(19) United States
(12) Patent Application Publication
(10) Pub. No.: US 2016/0288056 A1
(43) Pub. Date: Oct. 6, 2016

(54) POLYMERIC ANTIFOULING ADDITIVES FOR MEMBRANES

(71) Applicant: BASF SE, Ludwigshafen (DE)

(72) Inventors: Hermann BERGMANN, Osnabrueck (DE); Xiao FU, Singapore (SG); Xi DOU, Singapore (SG); Manivannan RAMANUJACHARY, Heidelberg (DE)

(73) Assignee: BASF SE, Ludwigshafen (DE)

(21) Appl. No.: 15/038,386

(22) PCT Filed: Nov. 21, 2014
(86) PCT No.: PCT/EP2014/075273

§ 371 Date: May 20, 2016

(30) Foreign Application Priority Data
Nov. 22, 2013 (EP) 13194077.7

(51) Int. Cl. B01D 65/08; B01D 69/06; B01D 69/02; B01D 67/00; B01D 71/68; B01D 61/18; B01D 61/14

(52) U.S. Cl. CPC B01D 65/08; B01D 61/18; B01D 69/06; B01D 61/145; B01D 67/0013; B01D 67/0016; B01D 71/68; B01D 69/02; B01D 2325/38; B01D 2325/36; B01D 2323/36; B01D 2325/48; B01D 2323/04; B01D 2323/02

(57) ABSTRACT

The present invention is directed to polymer compositions comprising a bulk material (P1) and an amphiphilic polyethersulfone block copolymer (P2) and to membranes prepared thereof. Furthermore, the present invention is directed to the use of amphiphilic polyethersulfone block copolymers as antifouling agents and/or pore size control agents in filtration membranes.

The present invention is directed to porous separation membranes comprising a porous surface layer prepared from polymer compositions comprising a bulk material (P1) and an amphiphilic polyethersulfone block copolymer (P2) and to corresponding polymer compositions for preparing said membranes. Furthermore, the present invention is directed to the use of amphiphilic polyethersulfone block copolymers as antifouling agents and/or pore size control agents in filtration membranes.

### BACKGROUND OF THE INVENTION

Polysulfone (PSf) and polyethersulfone (PESU) are both poly(arylene ether sulfone)s showing excellent thermal stability, oxidative resistance, optical transparency, and good solubility [1]. Since the excellent physicochemical property as well as the good membrane forming performance, the PSf and PESU are important membrane materials widely used in water treatment, hemodialysis, and juice concentration. However, the intrinsic hydrophobicity of the PES and PSf is one of the mainsprings that cause the fouling of membranes [2].

According to the mechanism of biofouling, hydrophilicity or antimicrobial modification is a facile and effective method to solve the problem. The main general approaches to control biofouling in terms of material design can be divided into “anti-adhesion” approaches to reduce initial macromolecular adsorption or attachment of organisms, and “antimicrobial” approaches which attack, disperse or suppress the activity of attached organisms.

Park et al., Biomaterials 27 (2006) 856-865 describes the synthesis of amphiphilic graft copolymers having polysulfone (PSf) backbones and poly(ethylene glycol) (PEG) side chains and the use of said polysulfone-graft-poly(ethylene glycol) (PSf-g-PEG) copolymers as additives in PSf membranes.

WO2011/123033 describes block copolymer membranes and methods to make them. Separation membranes made of said block copolymers as bulk material and not as additives to different polymeric bulk material is also disclosed.

CN 102 755 844 A discloses a preparation method for surface ionization modified polysulfone ultrafiltration membranes.

CN 103 193 941 discloses a polyether sulfone copolymer modified by sulphobetaine metacrylic acid ester as well as a preparation method and an application of the polyether sulfone copolymer. Said polyether sulfone copolymer is prepared by taking sulphobetaine metacrylic acid ester and polyether sulfone as raw materials, dimethylsulfoxide as a solvent and carrying out free radical polymerization under the action of a catalyst.

Despite of recent advances in the development of polysulfone-membranes, their characteristics are by no means optimal and further improvements are needed. Especially, the antifouling characteristics of membranes comprising PSf and other polymeric bulk material like PESU are in need of amelioration.

The provision of new polymer compositions and membranes easier and more economical to prepare which stably combine the excellent properties of PSf and PESU with the desirable properties of a hydrophilic/antimicrobial unit, in particular, the antifouling properties is highly desirable. Further, it is highly desirable that the hydrophilic/antimicrobial unit remains permanently in the membrane (matrix).

### SUMMARY OF THE INVENTION

The above problem is, in particular, solved by providing polymer compositions comprising a bulk material (e.g. polyethersulfone (PESU), sulfonated polyethersulfone, polysulfone (PSU), sulfonated polysulfone, polyphenylsulfone (PPSU), or sulfonated polyphenylsulfone) and particular amphiphilic PESU block copolymers. Furthermore, the above problem is solved by providing membranes with fully porous and sponge-like morphology prepared via the phase inversion process using said compositions. The amphiphilic PESU block copolymers are obtained by modifying PESU (A) with hydrophilic/antimicrobial block(s) (B) which act as antifouling unit (FIG. 1). The PESU moiety (A) of amphiphilic PESU block copolymers associates non-covalently with the bulk material and ensures that the antifouling (hydrophilic) unit (B) can remain in the produced membrane; the hydrophilic moiety points into the pores of the membrane. The presence in the membrane of the amphiphilic PESU block copolymer as additive reduces the fouling tendency. The methods described herein can be extended to produce for example sheet or hollow fiber membranes for various applications in the membrane industry. In particular, these newly developed membranes have the potential to be applied as ultrafiltration (UF) membranes in processes like hemodialysis, protein separation/fractionation, virus removal, recovery vaccines and antibiotics from fermentation broths, wastewater treatment, milk/dairy product concentration, concentration of fruit juice, etc.

More particularly, various amphiphilic PESU block copolymers were prepared and used together with a bulk material to provide polymer compositions. Said compositions were used to prepare porous separation membranes. The porous separation membranes comprising such amphiphilic PESU block copolymers as additives were employed to investigate the effect of the additive on UF performances. A PESU hollow fiber membrane with no additive was used as benchmark to compare the performances.

### BRIEF DESCRIPTION OF DRAWING

FIG. 1 shows a schematic representation of membranes with additives.

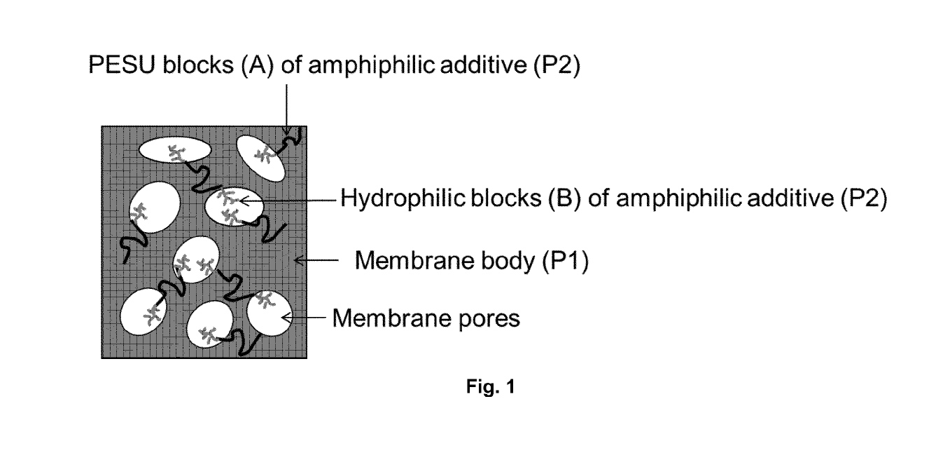

FIG. 2 shows typical hollow fiber morphology with and without additives.

FIG. 3 shows a bar graph comparing the surface analysis by TOF-SIMS for hollow fiber with 0 and 2 wt % additives: PES (C₆H₅⁺) to C₈H₁₁O₃⁺ from left to right.

FIG. 4 shows the depth profiling of a hollow fiber membrane with 2 wt % additive of example 2.1. The graph depicts the time dependent intensity signals of C₃H₇O⁺ and C₆H₉O₂⁺ (bottom signals) and C₆H₅⁺ (top signal).

FIG. 5 shows ¹NMR of hollow fiber with no additive.

FIG. 6 shows ¹NMR of hollow fiber with 2 wt % additive.

FIG. 7 shows ¹NMR of hollow fiber with 4 wt % additive.

FIG. 8 shows (A) a table with the cycle steps of the BSA fouling test for hollow fiber with 0, 2 and 4 wt % additive and the % of flux recovery after 1 and 2 cycles; (B) a bar graph comparing the water recovery after 1 cycle and 2 cycles BSA fouling test for hollow fiber with 0 and 4 wt % additive.

FIG. 9 shows the comparison of water recovery in a BSA fouling test for a hollow fiber with 2 wt % additive and without additives.

FIG. 10 shows the comparison of fouling tests using soil extract for a hollow fiber with 4 wt % additive and without additives.

FIG. 11 shows the antimicrobial activity of membranes with PtBAEMA-b-PESU-b-PtBAEMA (MF-010) and a control (MF-B) against E. Coli and S. Aureus.

FIG. 12 shows TOF SIMS (Time-of-Flight Secondary Ion Mass Spectrometry) depth profiling results for a multibore UF membrane with additive.

### DETAILED DESCRIPTION OF THE INVENTION

### A. General Definitions

“Porous surface layer” refers to a polymeric surface comprising plurality of pores of same or different sizes.

“Porous separation membrane” refers to a membrane comprising a polymeric surface comprising plurality of pores of same or different sizes. “Separation” may, in particular, be understood as “filtration”.

“Membranes for water treatment” are generally semi-permeable membranes which allow for separation of dissolved and suspended particles of water, wherein the separation process itself can be either pressure-driven or electrically driven

Examples of membrane applications are pressure-driven membrane technologies such as microfiltration (MF; pore size about 0.08 to 2 μm, for separation of very small, suspended particles, colloids, bacteria), ultrafiltration (UF; pore size about 0.005 to 0.2 μm; for separation of organic particles >1000 MW, viruses, bacteria, colloids), nanofiltration (NF, pore size 0.001 to 0.01 μm, for separation of organic particles >300 MW Trihalomethan (THM) precursors, viruses, bacteria, colloids, dissolved solids) or reverse osmosis (RO, pore size 0.0001 to 0.001 μm, for separation of ions, organic substances >100 MW).

“Additive” refers to a substance added in small amounts to a bulk material to modify one or more of its properties.

“Bulk material” refers to the polymer (e.g. polyethersulfone (PESU), sulfonated polyethersulfone, polysulfone (PSU), sulfonated polysulfone, polyphenylsulfone (PPSU), or sulfonated polyphenylsulfone) used as main component, (i.e. in an amount which is higher than the individual amounts of each of the other constituents of the composition) in the polymer composition.

“Amphiphilic polyethersulfone block copolymer” refers to a polyethersulfone block copolymer characterized by a hydrophobic block unit and a hydrophilic block unit.

“Block unit” refers to a building block of a polymer chain.

“Hydrophilic block unit” refers to the block unit which is hydrophilic in nature and “hydrophobic block unit” to the block unit which is hydrophobic in nature.

Molecular weights of polymers are, unless otherwise stated as Mw values, in particular determined via GPC in DMAc (dimethylacetamide). In particular, the GPC measurements were performed with dimethylacetamide (DMAc) containing 0.5 wt.-% lithium bromide as eluent at 80° C. Polyester copolymers were used as pre-column and column filling material. The calibration was performed with narrowly distributed PMMA standards. The flow rate was set at 1 ml/min, and the injection volume was 100 A.

Polydispersity index (PDI) is a measure of the distribution of molecular mass in a given polymer sample. The PDI is the calculated value of weight-average molecular weight divided by the number-average molecular weight. It indicates the distribution of individual molecular masses in a batch of polymers. The PDI has a value equal to or greater than 1. As the polymer chains approach uniform chain length, the PDI approaches 1.

“Sulfonated” means that the molecule carries at least one sulfonated residue of the type —SO₃H, or the corresponding metal salt form thereof of the type —SO₃⁻M⁺ like an alkali metal salt form with M=Na, K or Li.

“Substituted” means that a radical is substituted with 1, 2 or 3, especially 1, substituent which is in particular selected from the group consisting of halogen, alkyl, OH, alkoxy, SO₃⁻, NH₂, aminoalkyl, diaminoalkyl.

“Alkylene” represents a linear or branched divalent hydrocarbon group having 1 to 10 or 1 to 4 carbon atoms, as for example C₁-C₄-alkylene groups, like —CH₂—, —(CH₂)₂—, (CH₂)₃—, —(CH₂)₄—, —(CH₂)₂—CH(CH₃)—, —CH₂—CH(CH₃)—CH₂—, (CH₂)₄—.

“Alkyl” represents a linear or branched alkyl group having 1 to 8 carbon atoms. Examples thereof are: C₁-C₄-alkyl radicals selected from methyl, ethyl, n-propyl, isopropyl, n-butyl, 2-butyl, isobutyl or tert-butyl, or C₁-C₆-alkyl radicals selected from C₁-C₄-alkyl radicals as defined above and additionally pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl.

“Perfluorinated alkyl” represents a linear or branched alkyl group having 1 to 4 carbon atoms, more preferably 1 or 2 carbon atoms, wherein all the hydrogen atoms are replaced by fluorine atoms, such as trifluoromethyl.

“Aryl-alkyl” represents a linear or branched alkyl group having 1 to 4 carbon atoms in particular 1 or two carbon atoms, wherein one hydrogen atom is replaced by an aryl, such as in benzyl.

“Alkoxy-alkyl” represents a linear or branched alkyl group having 1 to 4 carbon atoms, more preferably 1 or 2 carbon atoms, wherein one or two hydrogen atoms are replaced by one or two alkoxy groups having 1 to 6, preferably 1 to 4, in particular 1 or 2 carbon atoms. Examples thereof are: C₁-C₆-alkoxy-C₁-C₄-alkyl radicals selected from methoxymethyl, 2-methoxyethyl, 2-methoxypropyl, 3-methoxypropyl, 2-methoxy-1-(methoxymethyl)ethyl, 2-methoxybutyl, 3-methoxybutyl, 4-methoxybutyl, ethoxymethyl, 2-ethoxyethyl, 2-ethoxypropyl, 3-ethoxypropyl, 2-ethoxy-1-(ethoxymethyl)ethyl, 2-ethoxybutyl, 3-ethoxybutyl, 4-ethoxybutyl.

“Aryl” represents a 6- to 12-membered, in particular 6- to 10-membered, aromatic cyclic radical. Examples thereof are: C₆-C₁₂-aryl such as phenyl and naphthyl.

“Alkoxy” represents a radical of the formula R—O—, wherein R is a linear or branched alkyl group having from 1 to 6, in particular 1 to 4 carbon atoms. Examples thereof are C₁-C₆-alkoxy radicals selected from methoxy, ethoxy, n-propoxy, isopropoxy, n-butoxy, 2-butoxy, iso-butoxy (2-methylpropoxy), tert-butoxy pentyloxy, 1-methylbutoxy, 2 methylbutoxy, 3-methylbutoxy, 2,2-dimethylpropoxy, 1-ethylpropoxy, hexyloxy, 1,1-dimethylpropoxy, 1,2-dimethylpropoxy, 1-methylpentyloxy, 2-methylpentyloxy, 3-methylpentyloxy, 4 methylpentyloxy, 1,1-dimethylbutyloxy, 1,2-dimethylbutyloxy, 1,3-dimethylbutyloxy, 2,2-dimethylbutyloxy, 2,3-dimethylbutyloxy, 3,3-dimethylbutyloxy, 1-ethylbutyloxy, 2-ethylbutyloxy, 1,1,2-trimethylpropoxy, 1,2,2-trimethylpropoxy, 1-ethyl-1-methylpropoxy and 1-ethyl-2-methylpropoxy.

“Heterocyclyl” represents a 3- to 12-membered heterocyclic radical including a saturated heterocyclic radical, an unsaturated non-aromatic heterocyclic radical, and a heteroaromatic radical (hetaryl), which generally have 3, 4, 5, 6 or 7 ring forming atoms. The heterocyclic radicals may be bound via a carbon atom (C-bound) or a nitrogen atom (N-bound). The heterocyclic radicals comprise 1, 2, or 3 heteroatoms selected from N, O, and S. “N-hetreocyclyl” comprises 1, 2, or 3 N-heteroatoms. Examples thereof are: C₃-C₁₂-heterocyclyl selected from pyridyl, furanyl, thienyl, N-pyrrolidinyl, indolyl.

“Halogen” represents F, Cl, Br, I, and in particular F or Cl, preferably Cl.

### B. Particular Embodiments

The present invention is directed to a polymer composition or, more particularly, to a separation membrane, more particularly a porous separation membrane, comprising a layer, in particular a porous surface layer, prepared from said polymer composition, said polymer composition comprising a bulk material (P1) in admixture with at least one amphiphilic polyether sulfone block copolymer (P2), wherein the amphiphilic polyether sulfone block copolymer (P2) comprises at least one, like 1, 2, 3 or 4, in particular 1, hydrophobic block unit (A) and at least one, like 1, 2, 3, 4 or 5, in particular 1 or 2, hydrophilic block units (B) of general formulae

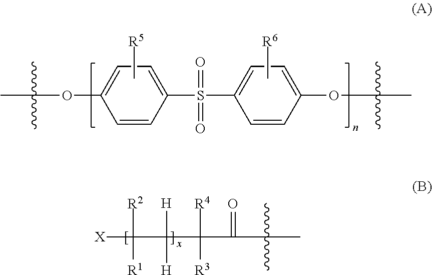

wherein
R¹ is —COO-alkylene-OR⁷, —COO-alkylene-SO₃⁻M⁺, —COO-alkylene-NR⁸R⁹R¹⁰, —CO—Z—N—R⁸R⁹, —COO-alkylene-NHR⁸, —COO-alkylene-N⁺R⁸R⁹R¹¹W⁻, or optionally substituted N-heterocyclyl (e.g. N-pyrrolidonyl);
R² is hydrogen, halogen, optionally substituted alkyl (e.g. methyl), perfluorinated alkyl, optionally substituted aryl, cyano, nitro, amino, or heterocyclyl;
R³, R⁴ independently are hydrogen, halogen, optionally substituted alkyl (e.g. methyl), perfluorinated alkyl, optionally substituted aryl, cyano, nitro, amino, or heterocyclyl;
R⁵, R⁶ independently are hydrogen, halogen, or sulfonic acid;
n is an integer in a range from 20 to 80, 30 to 70 or 40 to 50;
x is an integer in a range from 1 to 20, 2 to 15 or 5 to 10;
R⁷ is hydrogen, alkyl, or alkoxy-alkyl (e.g. 2-methoxy-ethyl);
R⁸, R⁹ independently are hydrogen, optionally substituted alkyl (e.g. Me, tBu);
R¹⁰ is alkylene-SO₃⁻ (e.g. —(CH₂)₃SO₃⁻);
R¹¹ is hydrogen, alkyl, aryl-alkyl;
Z is alkylene or a chemical bond;
X is hydrogen, halogen or another block unit (B) in which X, x, and R¹ to R⁴ are as defined above;
W is halogen, OTf, BF₄, BPh, PF₆ or SbF₆;
M is alkaline metal (Na, K, Li) or alkaline earth metal (e.g. Ca, Mg),
   and the bulk material (P1) is polyethersulfone (PESU), sulfonated polyethersulfone, polysulfone (PSU), sulfonated polysulfone, polyphenylsulfone (PPSU), sulfonated polyphenylsulfone, polyacrylonitrile (PAN), polyvinylidenefluoride (PVDF) or blends thereof;
   wherein said porous layer is optionally provided on a suitable support material.

In a preferred embodiment said polymer composition contains P1 and P2 in a weight ratio of P1:P2 of 1:0.0025 to 0.8, preferably 1:0.02 to 0.3, more preferably 1:0.1 to 0.25 most preferably 1:0.1 to 0.15.

In another embodiment the polymer P2 may be contained as additive in a solution of said polymer composition applied for preparing said porous layer in an amount lower than the amount of P1. For example said solution may contain 0.1 to 20 wt. % preferably 0.1 to 12 wt. %, more preferably 0.5 to 8 wt. % or 2 to 8 wt. % and in particular 1 to 5 wt. % of P2 based on the total weight of the polymer solution.

The polymer content (preferably the sum of P1 and P2) of said solution may be in the range of 5 to 65, preferably 8 to 40, more preferably 12 to 33 or most preferably 10 to 24 wt.-% based on the total weight of the polymer solution.

Correspondingly, the solvent content may be in the range of 35 to 95 or 60 to 92 or 67 to 88 or 76 to 90 wt.-% based on the total weight of the polymer solution. The solvent content may be somewhat lower id additional additives (different from P2) as defined herein below are added to the polymer composition.

Examples of suitable content ranges of P1 and P2 are:
P1:5-40 wt % and P2: 0.1-12 wt %
P1:10-25 wt % % and P2: 2-8 wt %
   based on the total weight of the polymer solution.

Preferably the content of additive P2 is lower than the content of bulk polymer P1.

For example P1 and P2 may be present in said solution in a weight ratio of P1:P2 of 1:0.0025 to 0.8, preferably 1:0.02 to 0.3, more preferably 1:0.1 to 0.25, and most preferably 1:0.1 to 0.15.

In particular, (P1) and (P2) are present in said solution or said porous layer as a physical, in particular homogenous, mixture and the two constituents of said mixture are not covalently linked to each other.

In connection with R¹ substituted N-heterocyclyl is preferably an N-heterocyclyl wherein two substituents form with the carbon atom to which they are attached a carbonyl, such as in N-pyrrolidon-2-yl.

In connection with R², R³, R⁴, R⁵, R⁶, R⁸ and R⁹ substituted alkyl is preferably C₁-C₄-alkyl substituted with halogen, alkyl, OH, alkoxy, like C₁-C₄-alkoxy, SO₃⁻, NH₂, aminoalkyl, diaminoalkyl, like amino C₁-C₄-alkyl, diamino C₁-C₄-alkyl

In connection with R², R³, R⁴, R⁵, R⁶, R⁸ and R⁹ substituted aryl is preferably O₆—O₁₂-aryl substituted with halogen, alkyl, like C₁-C₄-alkyl, OH, alkoxy, like C₁-C₄-alkoxy, SO₃⁻, NH₂, aminoalkyl, diaminoalkyl, like amino C₁-C₄-alkyl, diamino C₁-C₄-alkyl.

R¹ is preferably —COO-alkylene-OR⁷, —COO-alkylene-SO₃⁻M⁺, —COO-alkylene-NHR⁸, —COO-alkylene-N⁺R⁸R⁹R¹¹W⁻, —COO-alkylene-NR⁸R⁹R¹⁰, or N-pyrrolidonyl. Alkylene is in particular C₂-C₄ alkylene. In particular, R¹ is —COO—(CH₂)₂—OR⁷, —COO—(CH₂)₃—SO₃⁻M⁺, —COO—(CH₂)₂— N⁺R⁸R⁹R¹¹W⁻, or —COO—(CH₂)₂— NR⁸R⁹R¹⁰, or N-pyrrolidonyl.

R² is preferably hydrogen or alkyl, like C₁-C₄-alkyl (e.g. methyl). In particular, R² is hydrogen or methyl.

Preferably, R³ and R⁴ independently are hydrogen or alkyl, like C₁-C₄-alkyl (e.g. methyl); in particular, R³ and R⁴ are methyl.

Preferably, R⁵ and R⁶ independently are hydrogen or alkyl, like C₁-C₄-alkyl (e.g. methyl); in particular, R⁵ and R⁶ are hydrogen.

R⁷ is preferably hydrogen or alkoxy-alkyl (e.g. 2-methoxy-ethyl); in particular, R⁷ is hydrogen or 2-methoxy-ethyl.

Preferably, R⁸ and R⁹ independently are hydrogen or alkyl, like O₁-O₄-alkyl (e.g. Me, tBu). In particular, R⁸ and R⁹ independently are hydrogen, methyl, or tert-butyl.

R¹⁰ is preferably C₂-C₄ alkylene-SO₃⁻ (e.g. —(CH₂)₃SO₃⁻); in particular, R¹⁰ is —(CH₂)₃SO₃⁻.

R¹¹ is preferably hydrogen

M is preferably an alkaline metal (e.g. K).

W is preferably halogen, like Cl or F.

According to a preferred embodiment, the polymer composition comprises a bulk material (P1) and an amphiphilic polyethersulfone block copolymer (P2) of the general formula (I), wherein the bulk material is polyethersulfone (PESU).

According to one embodiment, the polymer composition comprises a bulk material (P1) and an amphiphilic polyethersulfone block copolymer (P2) wherein the amphiphilic polyethersulfone block copolymer (P2) comprising at least one hydrophobic block unit (A) and at least one hydrophilic block unit (B) has the structure B-A or B-A-B.

According to a preferred embodiment, the structure of the amphiphilic polyethersulfone block copolymer (P2) is B-A-B.

According to another embodiment, the polymer composition comprises a bulk material (P1) and an amphiphilic polyethersulfone block copolymer (P 2) wherein the amphiphilic polyethersulfone block copolymer (P2) comprising a hydrophobic block unit A and a hydrophilic block unit B has the general formula (I)

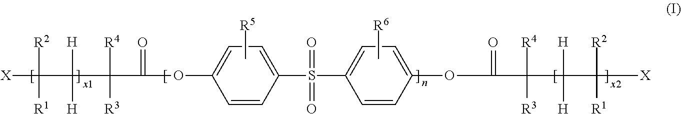

wherein x¹ and x² independently have the meaning of x and X, R¹, R², R³, R⁴, R⁵, R⁶, n and x are as defined above.

According to a preferred embodiment, the polymer composition comprises a bulk material (P1) and an amphiphilic polyethersulfone block copolymer (P2) of the general formula (I) wherein
R¹ is —COO-alkylene-OR⁷, —COO-alkylene-SO₃⁻M⁺, —COO-alkylene-NR⁸R⁹R¹⁰, —COO-alkylene-NHR⁸, —COO-alkylene-N⁺R⁸R⁹R¹¹W⁻, or N-pyrrolidonyl;
R² is hydrogen or alkyl (e.g. Me);
R³, R⁴ independently are alkyl (e.g. Me);
R⁵, R⁶ are hydrogen;
n is an integer in a range from 20 to 80, 30 to 70 or 40 to 50;
x¹, x² independently are integers in a range from 1 to 20, 2 to 15 or 5 to 10;
R⁷ is hydrogen or alkoxy-alkyl (e.g. 2-methoxy-ethyl);
R⁸, R⁹ independently are hydrogen or alkyl (e.g. Me, tBu);
R¹⁰ is alkylene-SO₃⁻ (e.g. —(CH₂)₃SO₃⁻);
R¹¹ is hydrogen, alkyl, like methyl or ethyl, or aryl-alkyl, like phenylmethyl;
W is halogen, OTf, BF₄, BPh, PF₆ or SbF₆, in particular halogen, like F or Cl;
X is halogen or hydrogen;
M is alkaline metal (e.g. Na, K, Li) or alkaline earth metal (e.g. Ca, Mg).

According to a further preferred embodiment, the polymer composition comprises a bulk material (P1) and an amphiphilic polyethersulfone block copolymer (P2) of the general formula (I) wherein
R¹ is —COO—(CH₂)₂—OR⁷, —COO—(CH₂)₃—SO₃⁻M⁺, —COO—(CH₂)₂—NR⁸R⁹R¹⁰, —COO-alkylene-NHR⁸, —COO-alkylene-N⁺R⁸R⁹R¹¹W⁻, or N-pyrrolidonyl;
R² is hydrogen or methyl;
R³, R⁴ are methyl;
R⁵, R⁶ are hydrogen;
n is an integer in a range from 20 to 80, 30 to 70 or 40 to 50;
x¹, x² independently are integers in a range from 1 to 20; 1 to 20, 2 to 15 or 5 to 10;
R⁷ is hydrogen or 2-methoxy-ethyl;
R⁸, R⁹ independently are hydrogen, methyl, or tert-butyl;
R¹⁰ is —(CH₂)₃SO₃⁻;
R¹¹ is hydrogen, methyl, ethyl, or phenylmethyl;
W is halogen, like F or Cl; X is hydrogen or bromine;
M is alkaline metal (e.g. K).

Examples of amphiphilic polyethersulfone block copolymers (P2) of the general formula (I) may include but are not limited to

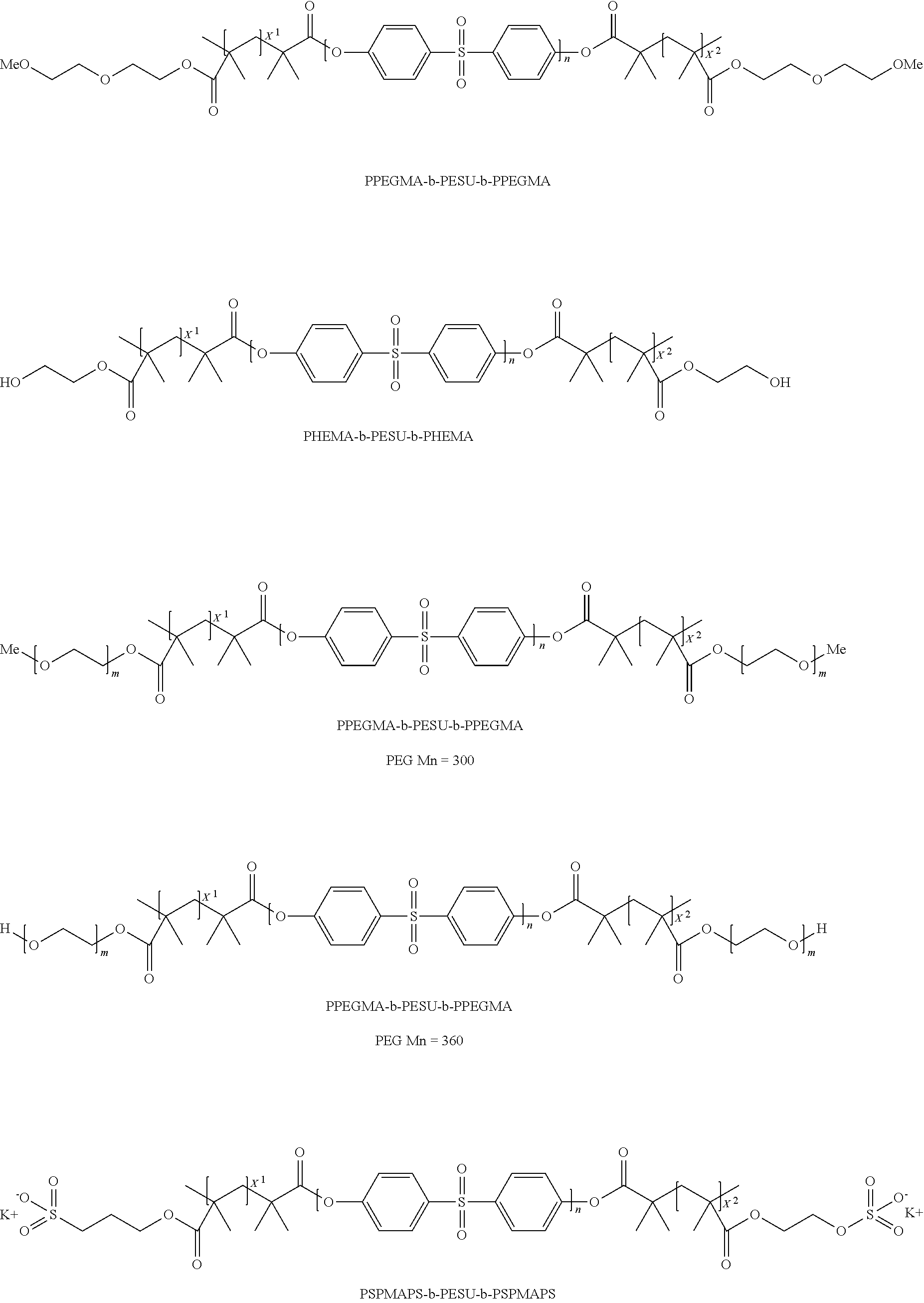

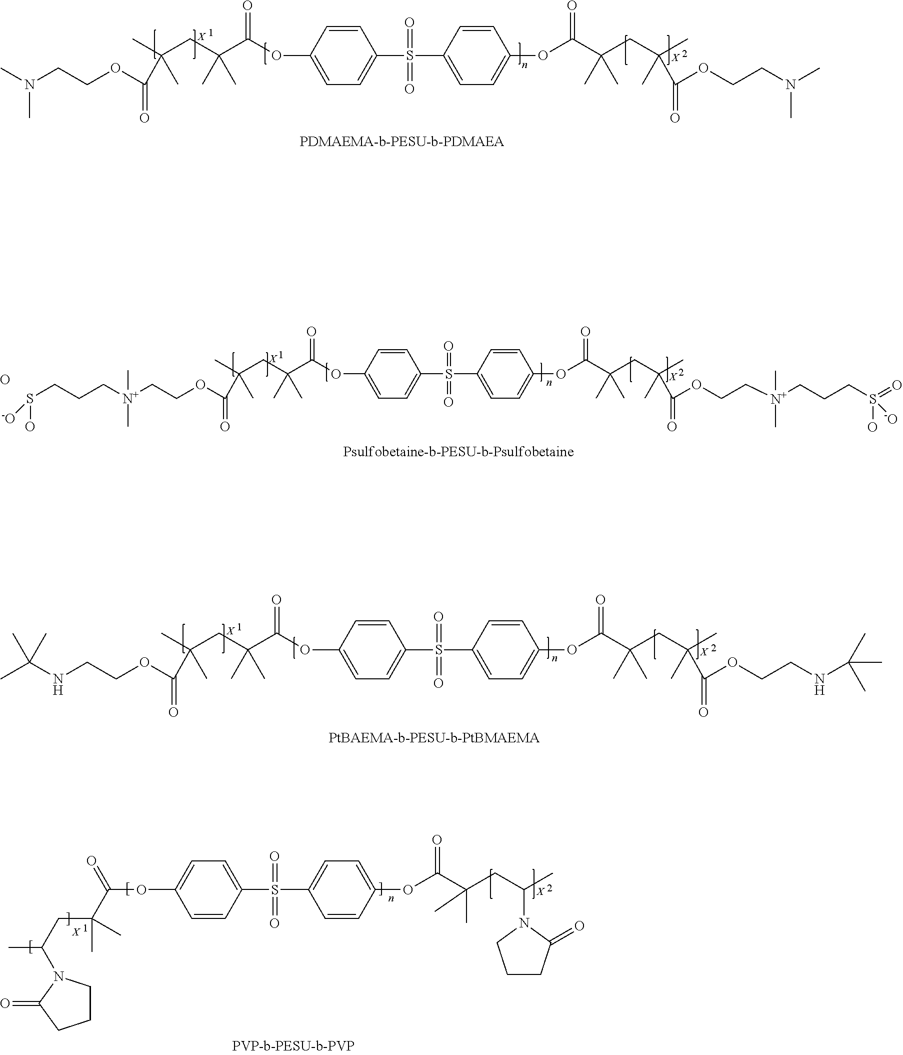

wherein x², n and m in the above formulae are defined as above in anyone of the preferred embodiments.

According to another embodiment, the polymer composition of anyone of the preceding embodiments comprises an amphiphilic polyethersulfone block copolymer (P2) wherein said amphiphilic polyethersulfone block copolymer (P2) comprises at least on hydrophilic unit (B) in an amount in the range of 1 to 90% and in particular 8 to 80 wt. % per total weight of the dried block copolymer (P2).

According to another embodiment, the polymer composition comprises an amphiphilic polyethersulfone block copolymer (P2) wherein said amphiphilic polyethersulfone block copolymer (P2) is obtainable by polymerizing a macroinitiator of the general formula M1a and atom transfer radical polymerization active monomers of general formula M1b

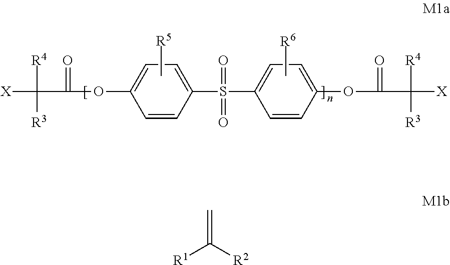

wherein R¹, R², R³, R⁴, R⁵, R⁶ and n are as defined above, and
Y is F, Cl, Br or I, in particular Br.

An example of macroinitiator M1a is

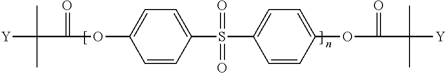

wherein Y is defined as above.

The term “atom Transfer Radical Polymerization (ATRP) refers to a living polymerization or a controlled radical polymerization (CRP). In the presence of a transition metal based catalyst (e.g. CuI), the polymer may grow to form a homogeneous polymer chain, which lead to low polydispersity.

Examples of suitable ATRP monomers of the type M1b which are to react with the macroinitiator are: acrylate, methacrylate, acrylamide, methacrylamide. Specific examples of suitable ATRP monomers of the type M1b include but are not limited to di(ethylene glycol) methyl ether methacrylate, 2-hydroxyethyl methacrylate, 3-sulfopropyl methacrylate, 2-(dimethylamino)ethyl methacrylate, 2-(tertbutylamino)ethyl methacrylate and NVP. The ATRP monomers (M1B) may be used either individually or as a combination thereof.

According to another embodiment, the polymer composition comprises an amphiphilic polyethersulfone block copolymer (P2) wherein said amphiphilic polyethersulfone block copolymer (P2) has a Mw in the range of 10.000 to 100.000, like 15.000 to 80.000, in particular 20.000 to 60.000 g/mol, as determined by Gel Permeation Chromatography (GPC) with N-dimethylacetamide (DMAc) solution.

According to another embodiment, the polymer composition comprises an amphiphilic polyethersulfone block copolymer (P2) wherein said amphiphilic polyethersulfone block copolymer (P2) has a polydispersity index in the range of 2 to 5, or 1.5 to 3, as determined by Gel Permeation Chromatography (GPC) with N-dimethylacetamide (DMAc) solution.

According to one embodiment, the porous separation membrane comprising a porous surface layer, which is prepared from a polymer composition as defined in anyone of the preceding embodiments may further comprise a support such as a non-woven fabric.

According to a preferred embodiment, said porous separation membrane is in the form of a sheet or hollow fiber.

The amphiphilic polyethersulfone block copolymer (P2) of the invention is used as additive in the porous separation membranes. A further preferred embodiment of the invention is directed to porous separation membranes, wherein said amphiphilic polyethersulfone block copolymer (P2) is contained as additive in an amount of 0.1 to 20 wt. %, preferably 0.5 to 8 wt. % and in particular 1 to 5 wt. %, like, in particular, based on the total weight of the polymer solution as used for preparing said porous surface layer.

The polymer content, in particular the content represented by the sum of (P2) and the polymeric bulk material (P1) as contained in said polymer solution is in the range of 5 to 65, preferably 8 to 40, more preferably 12 to 33 or most preferably 10 to 24 wt.-% based on the total weight of the solution.

The bulk material (P1) may be selected from PESU, sulfonated PESU, PSU, sulfonated PSU, PPSU, or sulfonated PPSU, polyacrylonitrile (PAN), polyvinylidenefluoride (PVDF) or blends of the aforementioned polymers.

Said solvent system for preparing said polymeric solution contains at least one solvent selected from N-methylpyrrolidone (NMP), N-dimethylacetamide (DMAc), dimethylsulfoxide (DMSO), dimethylformamide (DMF), triethylphosphate, tetrahydrofuran (THF), 1,4-dioxane, methyl ethyl ketone (MEK), or a combination thereof.

The solvent content may be in the range of 35 to 95 or 60 to 92 or 67 to 88 or 76 to 90 wt.-% based on the total weight of the polymer solution.

Additionally, said solution may contain at least one further additive selected from ethylene glycol, diethylene glycol, polyethylene glycol, glycerol, methanol, ethanol, isopropanol, polyvinylpyrrolidone (PVP), or a combination thereof, preferably glycerol, optionally in combination with PVP, wherein said additive is contained in said polymer solution in a range of 0-50 or 0-30 preferably 0.1-25 or more preferably 1-20 wt.-% per total weight of the polymer solution.

Specific examples of membranes according to the invention include but are not limited to membranes, wherein an amphiphilic polyethersulfone block copolymer (P2) (in particular PPEGMA-b-PESU-b-PPEGMA) is contained as additive in said polymer solution applied for preparing said membrane layer in an amount of 2 or 4 wt. % like, in particular, based on the total weight of the polymer solution.

According to another embodiment, the membrane of anyone of the preceding embodiments is an ultrafiltration membrane.

According to another embodiment, the present invention is directed to an ultrafiltration method making use of said ultrafiltration membrane. In particular, said ultrafiltration method is applied for hemodialysis, protein separation/fractionation, virus removal, recovery of vaccines and antibiotics from fermentation broths, wastewater treatment, milk/dairy product concentration, concentration of fruit juice, etc.

According to one embodiment, the amphiphilic polyethersulfone block copolymer (P2) of the general formula (I) according to the invention is used as antifouling agent and/or pore size control agent in filtration membranes.

According to one embodiment, a method of preparing a membrane according to the invention comprises

a) providing a dope solution comprising a dope solvent and a polymer composition according to the invention dissolved in said dope solvent;
b) performing a casting step or spinning step with said dope solution to form a polymer sheet or fiber structure; and
c) performing a phase inversion by contacting said sheet or fiber structure with a liquid coagulation medium.

### C. Further Embodiment of the Invention

The manufacture of membranes such as UF membranes and their use in filtration modules of different configuration is known in the art. See for example MC Porter et al. in Handbook of Industrial Membrane Technology (William Andrew Publishing/Noyes, 1990).

Preparation of the sponge-like, macrovoid free substrate layer (S) is performed by applying typical techniques for membrane formation, as described by C. A. Smolders et al in J. Membr. Sci.: Vol 73, (1992), 259.

A particular method of preparation is known as phase inversion method.

In a first step the bulk material (P1) (e.g. PESU, sulfonated PESU, PSU, sulfonated PSU, PPSU, or sulfonated PPSU) and polyvinylpyrrolidone K90 is dried, as for example at a temperature in the range of 80 to 120, as for example 100° C. under vacuum in order to remove excess liquid.

In a second step a homogeneous dope solution comprising the bulk material (P1) (e.g. PESU, sulfonated PESU, PSU, sulfonated PSU, PPSU, or sulfonated PPSU, polyacrylonitrile (PAN), polyvinylidenefluoride (PVDF) or blends of the aforementioned polymers), polyvinylpyrrolidone and an amphiphilic PESU block copolymer (P2) in a suitable solvent system is prepared. Said solvent system contains at least one solvent selected from N-methylpyrrolidone (NMP), N-dimethylacetamide (DMAc), dimethylsulfoxide (DMSO), dimethylformamide (DMF), triethylphosphate, tetrahydrofuran (THF), 1,4-dioxane, methyl ethyl ketone (MEK), or a combination thereof; and, additionally may contain at least one further additive selected from ethylene glycol, diethylene glycol, polyethylene glycol, glycerol, methanol, ethanol, isopropanol, polyvinylpyrrolidone, or a combination thereof, wherein said additive is contained in said polymer solution in a range of 0-50 or 0-30 or 0.1-25 or 1-20 wt.-% per total weight of the polymer solution.

The polymer content of the polymer solution is in the range of 5 to 65, preferably 8 to 40, more preferably 12 to 33 or most preferably 10 to 24 wt.-% based on the total weight of the solution.

For example a typical composition comprises PESU/PVP K90/Glycerin/N-methyl pyrrolidone (NMP>99.5%)/PPEGMA-b-PESU-PPEGMA with 23 wt % PPEGMA in a wt %-ratio of 13/6.4/6.4/72.2/2.

In a third step, a polymer sheet or fiber structure is formed by performing a casting step or spinning step with said dope solution. The casting step is performed on a solid support, as for example glass plate using a casting knife suitably of applying a polymer layer of sufficient thickness. The spinning step is performed by extruding the polymer dope solution via a spinneret.

Immediately afterwards, in a fourth step, the polymer sheet or the fiber structure are immersed in a coagulant bath, containing a water-based coagulation liquid, e.g. a tap water coagulant bath at 50° C. Optionally, water may be applied in admixture with at least one lower alcohol as coagulant bath, in particular methanol, ethanol, isopropanol, glycerol, and optionally in admixture with at least one solvent as defined above. The polymer sheet or fiber were soaked in water for at least 2 days with constant change of water to ensure complete removal of solvent in order to induce phase inversion.

As a result of this procedure a membrane substrate exhibiting a sponge-like structure with no macrovoids is obtained.

### Experimental Part

Unless otherwise stated, preparation of polymers is generally performed by applying standard methods of polymer technology. In general, the reagents and monomeric constituents as used herein are either commercially available or well known from the prior art or easily accessible to a skilled reader via disclosure of the prior art.

### Example 1

### Preparation of Macro-Initiator of Formula M1a

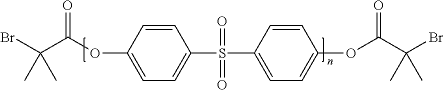

100 g (13.53 mmol) of PESU was dried for two days in the oven at 110° C. Afterwards, it was charged into a round bottomed flask and degassed. 800 mL of anhydrous N,N′-dimethylformamide was transferred into another round bottomed flask and the mixture was stirred until PESU fully dissolved. 8.14 mL (20.29 mmol) of N,N-Diisopropylethylamine and 0.38 g (1.56 mmol) of 4-Dimethylaminopyridine were then added into the round bottomed flask and the reaction mixture was cooled in an ice bath. While being stirred, 5.02 mL (20.29 mmol) of 2-bromo-2-methylpropionyl bromide was dropped into the reaction mixture. The reaction mixture was then stirred overnight at room temperature under nitrogen. The crude product was precipitated in methanol and filtered out followed by subsequently washing with methanol twice. The solid was re-dissolved in N,N′-dimethylformamide and precipitated in methanol once more. Wash cycle was repeated until no more 2-bromo-2-methylpropionyl bromide and N,N′-dimethylformamide peaks could be detected in ¹H-NMR spectrum. Product was dried at 40° C. in an oven to remove methanol residue. 80.2 g product was collected with a yield of 76%. 1H NMR (400 MHz, DMSO) δ 7.95 (d, Ar—H), 7.23 (d, Ar—H), 2.00 (s, —(CH₃)₂CBr).

### Example 2

### Preparation of Amphiphilic Block Copolymers (P1)

The amphiphilic block copolymers (P1) were prepared through ATRP. ATRP was conducted under typical condition, using CuI and PMDETA as a ligand, in DMF solution under 70° C. (scheme 1). Reactions were stopped after 20-24 h. By tuning the ratio of macroinitiators and ATRP active monomers, PESU was attached with different polymer degree of block copolymers. The products were obtained by precipitation from DMF into water. The purification was done by refluxing with boiling water for overnight. The hot water was refreshed for two to three times during the purification.

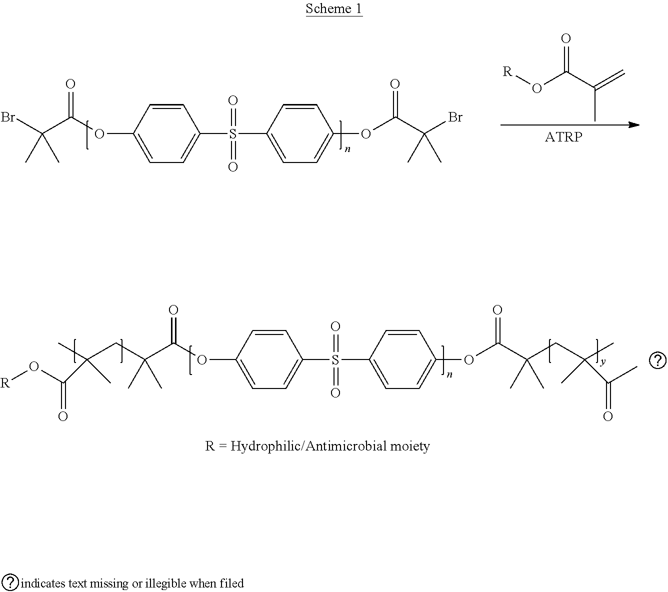

2.1) PPEGMA-b-PESU-b-PPEGMA with 23 wt % PPEGMA (PESU Mn=8.5 K, MM1)

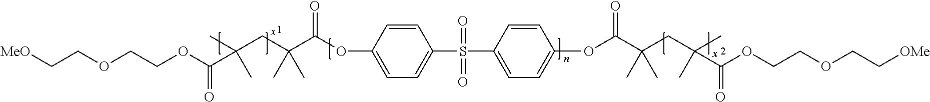

18.50 g of Macro-initiator of example 1 was dissolved in 140 mL of anhydrous DMF in a flame-dried schlenk tube. 10.60 ml di(ethylene glycol) methyl ether methacrylate was added to the colourless solution and purged with N₂ for 30 min. Then 2.41 mL of PMDETA and 0.83 g Cu(I)Br was added to the flask. The solution was then heated to 75° C. and stirred for 24 h. After being cooled to room temperature, the mixture was poured into 1000 mL of deionized water dropwisely. The precipitates were then collected, washed with deionized water and filtered out. After being redissolved in minimum amount of DMSO, the crude product was re-precipitated for one more time. The precipitate was then washed with hot water and filtered out for three times. The solid was then dried under vacuum at 100° C. giving 20.50 g of PPEGMA-b-PESU-b-PPEGMA with 23 wt % of PPEGMA content in a yield of 70%. ¹H NMR (400 MHz, DMSO) δ 7.95 (d, Ar—H), 7.23 (d, Ar—H), 4.07 (b, —CH₂COO), 3.54-3.29 (b, —CH₃OC₂H₄OCH₂CH₂OCO), 2.40-1.35 (b, —CH₂CCO), 1.19 and 1.01 (b, —CH₃CCO).

2.2) PPEGMA-b-PESU-b-PPEGMA with 49 wt % PPEGMA (PESU Mn=8.5 K)

15.00 g of Macro-initiator of example 1 was dissolved in 150 mL of anhydrous DMF in a flame-dried schlenk tube. 17.25 ml di(ethylene glycol) methyl ether methacrylate was added to the colourless solution and purged with N₂ for 30 min. Then 1.95 mL of PMDETA and 0.67 g Cu(I)Br was added to the flask. The solution was then heated to 75° C. and stirred for 24 h. After being cooled to room temperature, the mixture was poured into 1000 mL of deionized water dropwisely. The precipitates were then collected, washed with deionized water and filtered out. After being redissolved in minimum amount of DMSO, the crude product was re-precipitated for one more time. The precipitate was then washed with hot water and filtered out for three times. The solid was then dried under vacuum at 100° C. giving 19.80 g of PPEGMA-b-PESU-b-PPEGMA with 49 wt % of PPEGMA content in a yield of 61%. ¹H NMR (400 MHz, DMSO) δ 7.98 (d, Ar—H), 7.26 (d, Ar—H), 4.12 (b, —CH₂COO), 3.59-3.42 (b, —CH₃OC₂H₄OCH₂CH₂OCO), 2.41-1.40 (b, —CH₂CCO), 1.25 and 1.08 (b, —CH₃CCO).

2.3) PPEGMA-b-PESU-b-PPEGMA with 68 wt % PPEGMA (PESU Mn=8.5 K)

10.00 g of Macro-initiator of example 1 was dissolved in 100 mL of anhydrous DMF in a flame-dried schlenk tube. 34.50 ml di(ethylene glycol) methyl ether methacrylate was added to the colourless solution and purged with N₂ for 30 min. Then 1.30 mL of PMDETA and 0.45 g Cu(I)Br was added to the flask. The solution was then heated to 75° C. and stirred for 24 h. After being cooled to room temperature, the mixture was poured into 1000 mL of deionized water dropwisely. The precipitates were then collected, washed with deionized water and filtered out. After being redissolved in minimum amount of DMSO, the crude product was re-precipitated for one more time. The precipitate was then washed with hot water and filtered out for three times. The solid was then dried under vacuum at 100° C. giving 22.30 g of PPEGMA-b-PESU-b-PPEGMA with 68 wt % of PPEGMA content in a yield of 49%. ¹H NMR (400 MHz, DMSO) δ 7.98 (d, Ar—H), 7.26 (d, Ar—H), 4.11 (b, —CH₂COO), 3.59-3.37 (b, —CH₃OC₂H₄OCH₂CH₂OCO), 2.49-1.38 (b, —CH₂COO), 1.23 and 1.09 (b, —CH₃COO).

2.4) PPEGMA-b-PESU-b-PPEGMA with 75 wt % PPEGMA (PESU Mn=8.5 K)

10.00 g of Macro-initiator of example 1 was dissolved in 180 mL of anhydrous DMF in a flame-dried schlenk tube. 34.50 ml di(ethylene glycol) methyl ether methacrylate was added to the colourless solution and purged with N₂ for 30 min. Then 1.30 mL of PMDETA and 0.54 g Cu(I)Br was added to the flask. The solution was then heated to 75° C. and stirred for 24 h. After being cooled to room temperature, the mixture was poured into 1000 mL of deionized water dropwisely. The precipitates were then collected, washed with deionized water and filtered out. After being redissolved in minimum amount of DMSO, the crude product was re-precipitated for one more time. The precipitate was then washed with hot water and filtered out for three times. The solid was then dried under vacuum at 100° C. giving 31.50 g of PPEGMA-b-PESU-b-PPEGMA with 75 wt % of PPEGMA content in a yield of 62%. ¹H NMR (400 MHz, DMSO) δ 7.95 (d, Ar—H), 7.23 (d, Ar—H), 4.09 (b, —CH₂COO), 3.57-3.34 (b, —CH₃OC₂H₄OCH₂CH₂OCO), 2.46-1.30 (b, —CH₂CCO), 1.21 and 1.07 (b, —CH₃CCO).

2.5) PHEMA-b-PESU-b-PHEMA with 25 wt % PHEMA (PESU Mn=8.5 K)

5.00 g of Macro-initiator of example 1 was dissolved in 50 mL of anhydrous DMF in a flame-dried schlenk tube. 4.06 ml 2-hydroxyethyl methacrylate was added to the colourless solution and purged with N₂ for 15 min. Then 0.58 mL of PMDETA and 0.20 g Cu(I)Br was added to the flask. The solution was then heated to 75° C. and stirred for 24 h. After being cooled to room temperature, the mixture was poured into 500 mL of deionized water dropwisely. The precipitates were then collected, washed with deionized water and filtered out. After being redissolved in minimum amount of DMSO, the crude product was re-precipitated for one more time. The precipitate was then washed with hot water and filtered out for three times. The solid was then dried under vacuum at 100° C. giving 6.20 g of PHEMA-b-PESU-b-PHEMA with 25 wt % of PHEMA content in a yield of 65%. ¹H NMR (400 MHz, DMSO) δ 7.95 (d, Ar—H), 7.22 (d, Ar—H), 4.79 (b, —OHCH₂), 3.87 (b, —CH₂COO), 3.55 and 3.33 (b, —CH₂OH), 2.15-1.35 (b, —CH₂CCO), 1.23 and 0.82 (b, —CH₃CCO).

2.6) PPEGMA-b-PESU-b-PPEGMA with 30 wt % PPEGMA (PESU Mn=8.5 K)

20.00 g of Macro-initiator of example 1 was dissolved in 180 mL of anhydrous DMF in a flame-dried schlenk tube. 10.20 ml poly(ethylene glycol) methacrylate (Mn=360, ending group OH) was added to the colourless solution and purged with N₂ for 30 min. Then 2.60 mL of PMDETA and 0.89 g Cu(I)Br was added to the flask. The solution was then heated to 80° C. and stirred for 24 h. After being cooled to room temperature, the mixture was poured into 1500 mL of deionized water dropwisely. The precipitates were then collected, washed with deionized water and filtered out. After being redissolved in minimum amount of DMSO, the crude product was re-precipitated for one more time. The precipitate was then washed with hot water and filtered out for three times. The solid was then dried under vacuum at 100° C. giving 17.40 g of PPEGMA-b-PESU-b-PPEGMA with 30 wt % of PPEGMA content in a yield of 56%. 1H NMR (400 MHz, DMSO) δ 7.95 (d, Ar—H), 7.22 (d, Ar—H), 4.55 (b, —OHCH₂), 4.00 (b, —CH₂COO), 3.47 and 3.36 (b, —CH₂OH), 1.83 (b, —CH₂CCO), 1.23 and 0.77 (b, —CH₃CCO).

2.7) PPEGMA-b-PESU-b-PPEGMA with 31 wt % PPEGMA (PESU Mn=8.5 K)

20.00 g of Macro-initiator of example 1 was dissolved in 200 mL of anhydrous DMF in a flame-dried schlenk tube. 14.72 ml poly(ethylene glycol) methyl ether methacrylate (Mn=300, ending group OCH₃) was added to the colourless solution and purged with N₂ for 30 min. Then 2.60 mL of PMDETA and 0.89 g Cu(I)Br was added to the flask. The solution was then heated to 80° C. and stirred for 24 h. After being cooled to room temperature, the mixture was poured into 1500 mL of deionized water dropwisely. The precipitates were then collected, washed with deionized water and filtered out. After being redissolved in minimum amount of DMSO, the crude product was re-precipitated for one more time. The precipitate was then washed with hot water and filtered out for three times. The solid was then dried under vacuum at 100° C. giving 20.0 g of PPEGMA-b-PESU-b-PPEGMA with 31 wt % of PPEGMA in a yield of 57%. ¹H NMR (400 MHz, DMSO) δ 7.95 (d, Ar—H), 7.23 (d, Ar—H), 3.97 (b, —CH₂COO), 3.62-3.12 (b, —CH₃O(C₂H₄O)m), 1.69 (b, —CH₂CCO), 1.07-0.75 (b, —CH₃CCO).

2.8) PSPMAPS-b-PESU-b-PSPMAPS with 15 wt % PSPMAPS (PESU Mn=8.5 K)

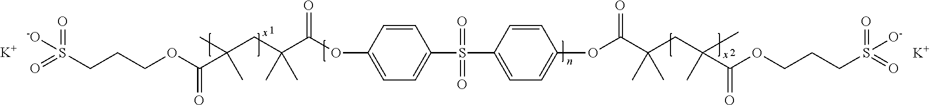

7.00 g of Macro-initiator of example 1 was dissolved in 70 mL of anhydrous DMF in a flame-dried schlenk tube. 2.38 g 3-sulfopropyl methacrylate potassium salt was added to the colourless solution and purged with N₂ for 15 min. Then 0.81 mL of PMDETA and 0.28 g Cu(I)Br was added to the flask. The solution was then heated to 75° C. and stirred for 24 h. After being cooled to room temperature, the mixture was poured into 500 mL of deionized water dropwisely. The precipitates were then collected, washed with deionized water and filtered out. After being redissolved in minimum amount of DMSO, the crude product was re-precipitated for one more time. The precipitate was then washed with hot water and filtered out for three times. The solid was then dried under vacuum at 100° C. giving 6.0 g of PSPMAPS-b-PESU-b-PSPMAPS with 15 wt % of PSPMAPS content in a yield of 64%. ¹H NMR (400 MHz, DMSO) δ 7.95 (d, Ar—H), 7.23 (d, Ar—H), 4.01 (b, —CH₂COO), 3.58 (b, —CH₂SO₃), 2.92 (b, —CH₂CH₂SO₃), 1.92 (b, —CH₂CCO), 1.37-0.68 (b, —CH₃CCO).

2.9) PDMAEMA-b-PESU-b-PDMAEMA with 9.4 wt % PDMAEMA (PESU Mn=8.5 K) (not According to the Invention)

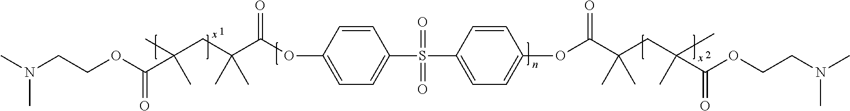

20.00 g of Macro-initiator of example 1 and 52 ml 2-(Dimethylamino)ethyl methacrylate (DMAEMA) were dissolved in 180 mL of anhydrous DMF in a 500 ml schlenk tube. The solution was purged with N₂ for 30 min. 3.40 mL of tris[2-(dimethylamino)ethyl] amine and 0.90 g Cu(I)Br were added to the schlenk tube in the glovebox. The solution was then heated to 85° C. under nitrogen for 22 h. The reaction mixture was cooled to room temperature and precipitated in 1.6 L of deionized water. The suspension was centrifuged for 10 min and water was decanted. The process of washing with water, centrifuging and decanting was repeated another 2 times. The residue was then washed with hot water (75° C.), filtered and dried under vacuum at 100° C. giving 18.77 g of PDMAEMA-b-PES-b-PDMAEMA with 9.4 wt % of PDMAEMA content in a yield of 27%. ¹H NMR (400 MHz, DMSO) δ 7.99-7.97 (d, Ar—H), 7.28-7.26 (d, Ar—H), 3.97 (b, —CH₂COO), 2.17-2.15 (b, —N(CH₃)₂) and 1.25-0.80 (b, —CH₂CCO and —CH₃CCO).

2.10) Psulfobetaine-b-PESU-b-Psulfobetaine with 18 wt % Psulfobetaine (PESU Mn=8.5 K)

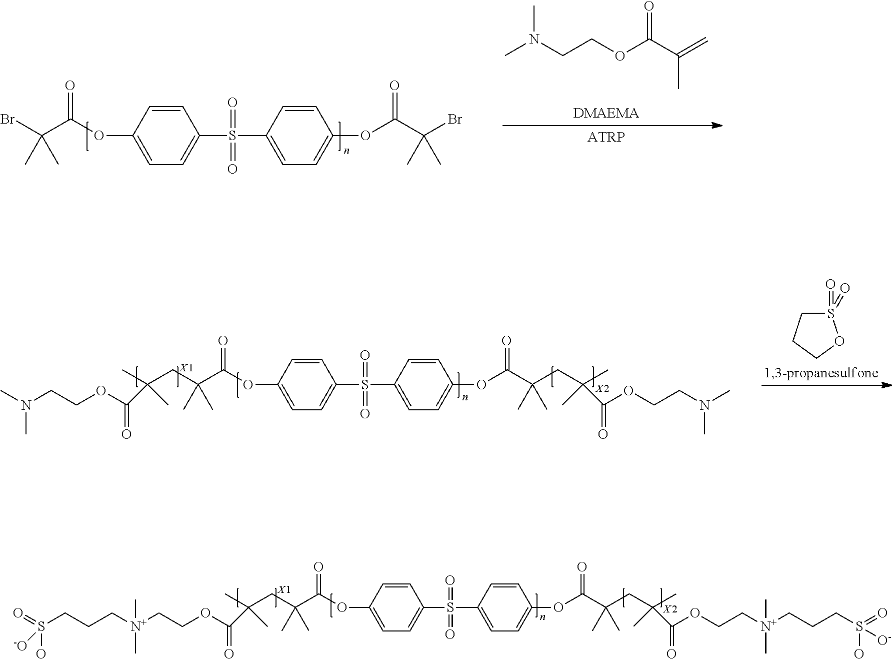

18.00 g of PDMAEMA-b-PES-b-PDMAEMA was dissolved in 180 mL of anhydrous DMF at 70° C. under nitrogen. 2.63 g of propane sultone was then added and the reaction mixture was heated at 70° C. under nitrogen for 4 h followed by room temperature for 16 h. The reaction mixture was concentrated and precipitated in 1.6 L of deionized water. The suspension was centrifuged for 10 min and water was decanted. The process of washing with water, centrifuging and decanting was repeated another 3 times. The residue was dried in the oven at 100° C. giving 15.67 g of Psulfobetaine-b-PESU-b-Psulfobetaine with 18 wt % Psulfobetaine content in a yield of 76%. ¹H NMR (400 MHz, DMSO) δ 7.97-7.95 (d, Ar—H), 7.25-7.23 (d, Ar—H), 4.37 (b, —CH₂COO), 3.67 (b, —CH₂SO₃), 3.10-3.01 (b, —CH₂NCH₂) 2.05-2.03 (b, —N(CH₃)₂) and 1.27-0.83 (b, —CH₂CCO and —CH₃CCO).

2.11) PHEMA-b-PESU-b-PHEMA with 31 wt % PHEMA (PESU Mn=4.6 K)

5.00 g of Macro-initiator of example 1 was dissolved in 50 mL of anhydrous DMF in a flame-dried schlenk tube. 3.44 ml 2-hydroxyethyl methacrylate was added to the colourless solution and purged with N₂ for 15 min. Then 0.81 mL of PMDETA and 0.28 g Cu(I)Br was added to the flask. The solution was then heated to 75° C. and stirred for 24 h. After being cooled to room temperature, the mixture was poured into 500 mL of deionized water dropwisely. The precipitates were then collected, washed with deionized water and filtered out. After being redissolved in minimum amount of DMSO, the crude product was re-precipitated for one more time. The precipitate was then washed with hot water and filtered out for three times. The solid was then dried under vacuum at 100° C. giving 7.0 g of PHEMA-b-PESU-b-PHEMA with 31 wt % of PHEMA content in a yield of 79%. ¹H NMR (400 MHz, DMSO) δ 7.95 (d, Ar—H), 7.22 (d, Ar—H), 4.79 (b, —OHCH₂), 3.86 (b, —CH₂COO), 3.55 and 3.33 (b, —CH₂OH), 2.20-1.37 (b, —CH₂CCO), 1.23 and 0.75 (b, —CH₃CCO).

2.12) PPEGMA-b-PESU-b-PPEGMA with 39 wt % PPEGMA (PESU Mn=19 K)

25.00 g of Macro-initiator of example 1 was dissolved in 250 mL of anhydrous DMF in a flame-dried schlenk tube. 25.00 ml di(ethylene glycol) methyl ether methacrylate was added to the colourless solution and purged with N₂ for 30 min. Then 0.80 mL of PMDETA and 0.27 g Cu(I)Br was added to the flask. The solution was then heated to 80° C. and stirred for 24 h. After being cooled to room temperature, the mixture was poured into 2000 mL of deionized water dropwisely. The precipitates were then collected, washed with deionized water and filtered out. After being redissolved in minimum amount of DMSO, the crude product was re-precipitated for one more time. The precipitate was then washed with hot water and filtered out for three times. The solid was then dried under vacuum at 100° C. giving 22.30 g of PPEGMA-b-PESU-b-PPEGMA with 39 wt % of PPEGMA content in a yield of 45%. ¹H NMR (400 MHz, DMSO) δ 7.95 (d, Ar—H), 7.23 (d, Ar—H), 3.99 (b, —CH₂COO), 3.57-3.20 (b, —CH₃OC₂H₄OCH₂CH₂OCO), 2.15-1.20 (b, —CH₂CCO), 0.93 and 0.77 (b, —CH₃CCO).

2.13) PtBAEMA-b-PESU-b-PtBAEMA with 31 wt % PtBAEMA (PESU Mn=8.5 K)

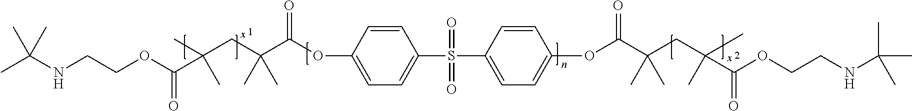

20.00 g of Macro-initiator of example 1 was dissolved in 160 mL of anhydrous DMF in a flame-dried schlenk tube. 63.20 ml 2-(tert-butylamino) ethyl methacrylate was added to the colourless solution and purged with N₂ for 30 min. Then 2.60 mL of PMDETA and 0.89 g Cu(I)Br was added to the flask. The solution was then heated to 80° C. and stirred for 24 h. After being cooled to room temperature, the mixture was poured into 1000 mL of deionized water dropwisely. The precipitates were then collected, washed with deionized water and filtered out. After being redissolved in minimum amount of DMSO, the crude product was re-precipitated for one more time. The precipitate was then washed with hot water and filtered out for three times. The solid was then dried under vacuum at 100° C. giving 51.40 g of PtBAEMA-b-PESU-b-PtBAEMA with 31 wt % of PtBAEMA content in a yield of 66%. ¹H NMR (400 MHz, DMSO) δ 7.98 (d, Ar—H), 7.26 (d, Ar—H), 3.92 (b, —CH₂COO), 2.68 (b, —CH₂NH), 2.00-1.40 (b, —CH₂CCO), 1.35-0.78 (b, —CH₃CCO), 1.02 (b, —(CH₃)₃C).

2.14) PVP-b-PESU-b-PVP with 33 wt % PVP

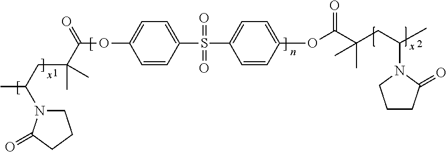

5.00 g of Macro-initiator of example 1 was dissolved in 100 mL NVP (pretreated by passing through a short silica column quickly) in a reaction The solution was purged with nitrogen gas for 15 min. A mixture of Cu(I)Br (184 mg), cyclam (514 mg) and 50 mL DMF was added dropwisely into the reaction flask. The mixture was then heated to 60° C. and stirred for 6 h. After cooling down, the reaction was quenched with 10 mL ethanol. After the mixture was poured into 900 mL diethyl ether, the crude product precipitated out. The crude product was collected, washed with diethyl ether and filtered. After being redissolved in small amount of dichloromethane, the crude product was re-precipitated in diethyl ether for another two times following the aforementioned procedure. The precipitates was then washed with water twice. After being dried, the solid was further washed with Soxhlet extraction for 18 h. The residue was collected and dissolved in DMSO and filtered through cotton wools. The filtrate was then dropped into EtOAc/Et₂O (1/2) solution and the desired product precipitated. The product was then washed with EtOAc/Et₂O (1/2) and dried under vacuum at 110° C. giving 3.78 g PVP-b-PES-b-PVP with 33 wt % of PVP content with a yield of 51%. ¹H NMR (400 MHz, DMSO) δ 7.98 (d, Ar—H), 7.26 (d, Ar—H), 3.73 and 3.54 (b, —CHN), 3.14 (b, —CH₂N), 2.21 and 2.05 (b, —CH₂CO), 1.85 (b, —CH₂CH₂CO), 1.61 and 1.27 (b, —CH₂CH). ¹³C NMR (100 MHz, DMSO) δ 173.7, 159.4, 136.6, 130.5, 130.2, 130.1, 129.7, 120.6, 120.1, 119.7, 119.2, 104.6, 30.9, 18.0. GPC (mobile phase: DMAc+0.5% LiBr, 80° C., flow rate: 1 ml/min, injection volume: 100 μL, column combination: GRAM pre-column, GRAM 30A, GRAM 1000A and GRAM 1000A): Mn 12920, Mw 28270, PDI: 2.2.

2.15) PVP-b-PESU-b-PVP with 47 wt % PVP

5.00 g of macro-initiator of example 1 was dissolved in 100 mL NVP (pretreated by passing through a short silica column quickly) in the reaction flask of an automatic reaction robot. The reaction apparatus was set up and the solution was purged with nitrogen for 15 min. A solution of Cu(I)Br (184 mg) and cyclam (256 mg) in 10 mL IPA and 40 mL of DMF was added to the reaction mixture. The solution was then heated to 60° C. under stirring. The reaction was carried at 60° C. for 6 h and cooled to room temperature followed by quenching with 10 mL of ethanol. The reaction mixture was then added to 900 mL of diethyl ether dropwisely. The precipitates were collected, washed with diethyl ether and filtered out. After being redissolved in minimum amount of dichloromethane, the crude product was re-precipitated for another two times. The precipitates was then suspended in water and filtered out for two times. After being dried, the solid was further washed with Soxhlet extraction for 18 h. The residue was collected and dissolved in DMSO and filtered through cotton wool. The filtered solution was then precipitated in EtOAc/Et₂O (1/2). The solid was then washed with EtOAc/Et₂O (1/2) and dried under vacuum at 110° C. giving 6.60 g PVP-b-PES-b-PVP with 47 wt % of PVP content in a yield of 52%. ¹H NMR (400 MHz, DMSO) δ 7.98 (d, Ar—H), 7.26 (d, Ar—H), 3.73 and 3.54 (b, —CHN), 3.14 (b, —CH₂N), 2.21 and 2.05 (b, —CH₂CO), 1.85 (b, —CH₂CH₂CO), 1.61 and 1.27 (b, —CH₂CH). ¹³C NMR (100 MHz, DMSO) δ 175.0, 174.0, 159.8, 137.1, 130.9, 130.6, 130.3, 120.64, 120.1, 105.0, 32.0, 30.0, 19.0, 17.0. GPC (mobile phase: DMAc+0.5% LiBr, 80° C., flow rate: 1 ml/min, injection volume: 100 μL, column combination: GRAM pre-column, GRAM 30A, GRAM 1000A and GRAM 1000A): Mn 14440, Mw 34400, PDI: 2.4.

2.16) PVP-b-PESU-b-PVP with 59 wt % PVP

3.00 g of macro-initiator of example 1 was dissolved in 100 mL NVP (pretreated by passing through a short silica column quickly) in the reaction flask of an automatic reaction robot. The reaction apparatus was set up and the solution was purged with nitrogen for 15 min. A mixture of Cu(I)Br (100 mg) and cyclam (155 mg) in 50 mL of DMF was added to the reaction mixture. The solution was then heated to 60° C. under stirring. The reaction was carried at 60° C. for 6 h and cooled to room temperature followed by quenching with 10 mL of ethanol. The reaction mixture was then added to 900 mL of diethyl ether dropwisely. The precipitates were collected, washed with diethyl ether and filtered out. With redissolved in minimum amount of dichloromethane, the crude product was re-precipitated for another two times. The precipitates was then suspended in water and filtered out for two times. After being dried, the solid was further washed with Soxhlet extraction for 36 h. The residue was collected and dissolved in DMSO and filtered through cotton wool. The filtered solution was then precipitated in EtOAc/Et₂O (1/2). The solid was then washed with EtOAc/Et₂O (1/2). The solid residue was dried under vacuum at 110° C. to provide 3.64 g PVP-b-PES-b-PVP with 59 wt % of PVP content in a yield of 49%. ¹H NMR (400 MHz, DMSO) δ 7.97 (d, Ar—H), 7.27 (d, Ar—H), 3.73 and 3.54 (b, —CHN), 3.14 (b, —CH₂N), 2.19 and 2.05 (b, —CH₂CO), 1.86 (b, —CH₂CH₂CO), 1.61 and 1.31 (b, —CH₂CH). ¹³C NMR (100 MHz, DMSO) δ 173.5, 159.4, 136.6, 130.2, 130.1, 120.1, 119.7, 104.6, 30.9, 17.9. GPC (mobile phase: DMAc+0.5% LiBr, 80° C., flow rate: 1 ml/min, injection volume: 100 μL, column combination: GRAM pre-column, GRAM 30A, GRAM 1000A and GRAM 1000A): Mn 17170, Mw 48300, PDI: 2.8.

### Example 3a

### Membrane Fabrication and Characterization

PESU E3010 and PVP K90 were dried at 100° C. under vacuum prior to dope preparation. 300 g of dope consisting of the composition in table 1 was prepared. The dope was left to stir overnight to obtain a homogeneous solution. The dope solution was left overnight without stirring for degasification before pouring in the spinning pump.

TABLE 1
Dope compositions and spinning parameters used for hollow fiber
fabrication

| | HF-05B | HF-04B | HF-06B |
|---|---|---|---|
| | PESU | PESU | PESU |
| | E3010/PVP | E3010/PVP | E3010/PVP |
| Dope | K90/Glycerin/ | K90/Glycerin/ | K90/Glycerin/ |
| composition | NMP = | NMP/MM1* = | NMP/MM1* = |
| (wt %) | 13/6.4/6.4/74.2 | 13/6.4/6.4/72.2/2 | 13/6.4/6.4/70.2/4 |
| Dope flow rate | | 2.5 | |
| (ml/min) | | | |
| Bore fluid | | NMP/water = | |
| composition | | 20/80 | |
| (wt %) | | | |
| Bore fluid flow | | 3.5 | |
| rate (ml/min) | | | |
| Air gap distance | | 20 | |
| (cm) | | | |
| Take up speed | | 4.2 | |
| (m/min) | | | |
| Coagulation bath | | Tap water | |
| | | (50 ± 2° C.) | |
| Temperature | | 23 ± 1 | |
| (° C.) | | | |
| Spinneret | | 1.6/0.8 | |
| dimension | | | |
| (OD/ID) mm | | | |

*MM1 is PPEGMA-b-PESU-b-PPEGMA with 23 wt % PPEGMA

The resultant hollow fibers were soaked in DI water overnight to allow complete solvent exchange. Subsequently, the hollow fibers were soaked in 2000 ppm NaOCl solution at 60° C. for 2 hours. The fibers were then washed in DI water for 3 times. A small bundle of fibers were then placed in the freezer overnight prior to freeze drying. Glycerol/water of composition 50/50 wt % was prepared and the remaining fibers were soaked inside with gentle stirring for 2 days. The fibers were then removed from the glycerol/water solution and air-dried for 1 day. 5 fibers from each spinning condition were then bundled to form a membrane module.

The freeze-dried hollow fibers were freeze fractured in liquid N₂ and subsequently coated in platinum for viewing under field emission scanning electron microscopy.

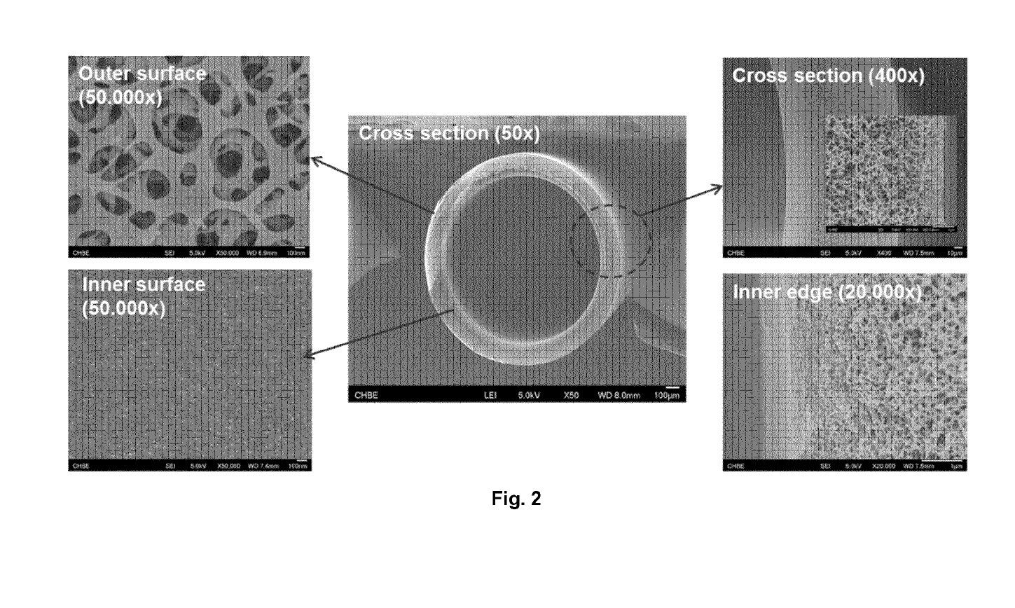

FIG. 2. shows typical hollow fiber morphology with and without additives. It can be observed that the inner surface is much denser as compared to the outer surface which is highly porous.

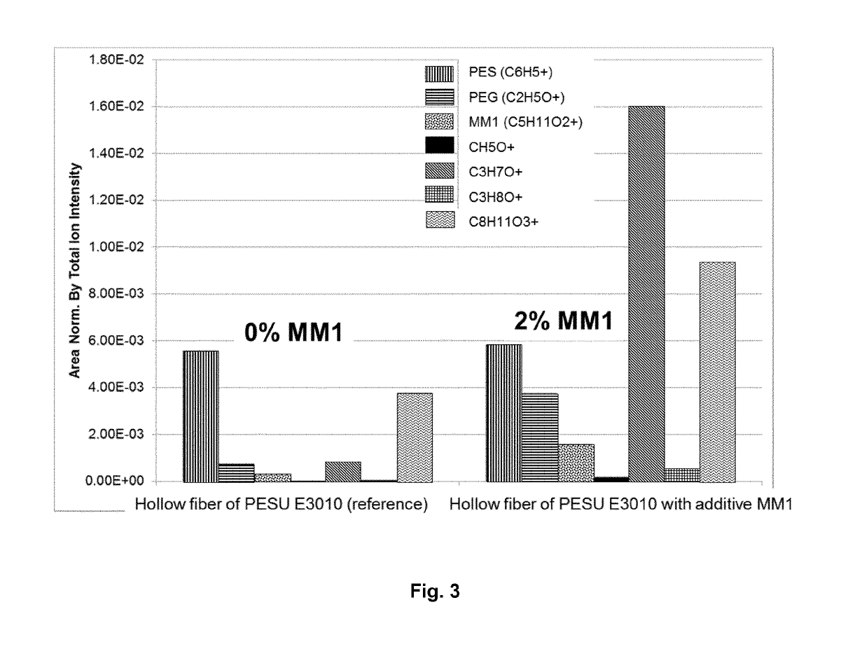

FIG. 3. shows the comparisons of surface analysis by TOF-SIMS for hollow fiber with and without additive.

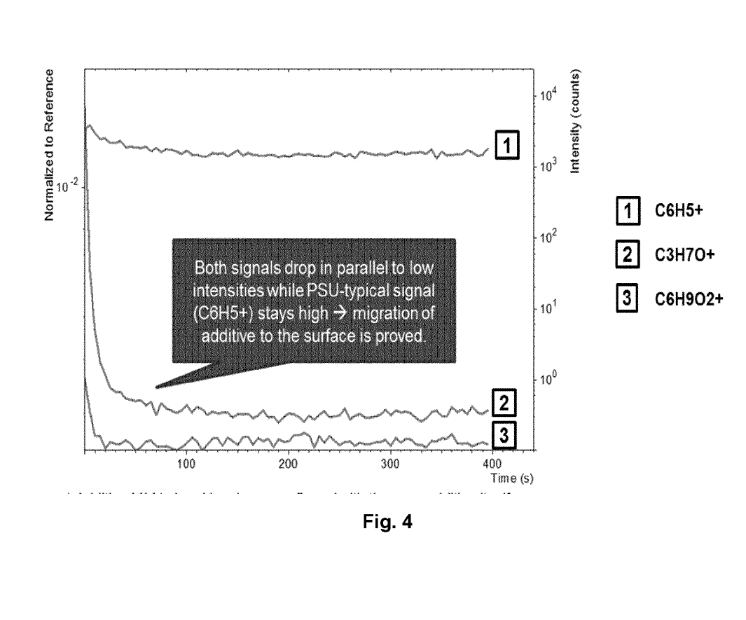

FIG. 4. shows the depth profiling of hollow fiber membrane with 2 wt % additive of example 2.1.

From the TOF-SIMS results in FIGS. 3 and 4, it is proven that the additive has migrated to the surface of the hollow fiber. As compared to blank hollow fibers, the PEGMA fragments in the hollow fiber with additive are clearly identified.

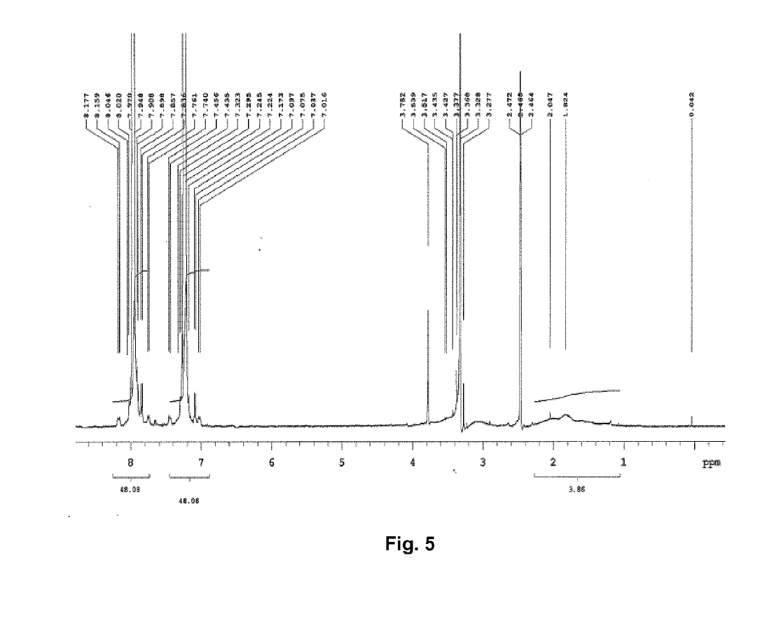

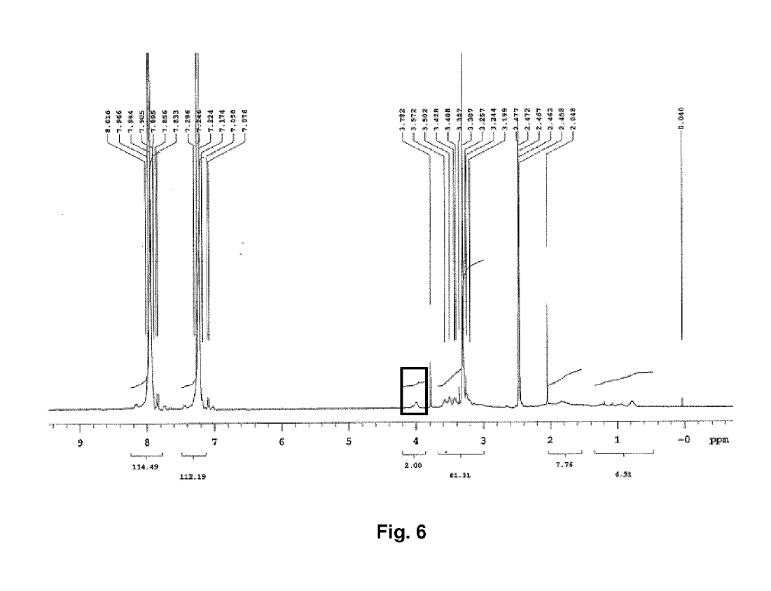

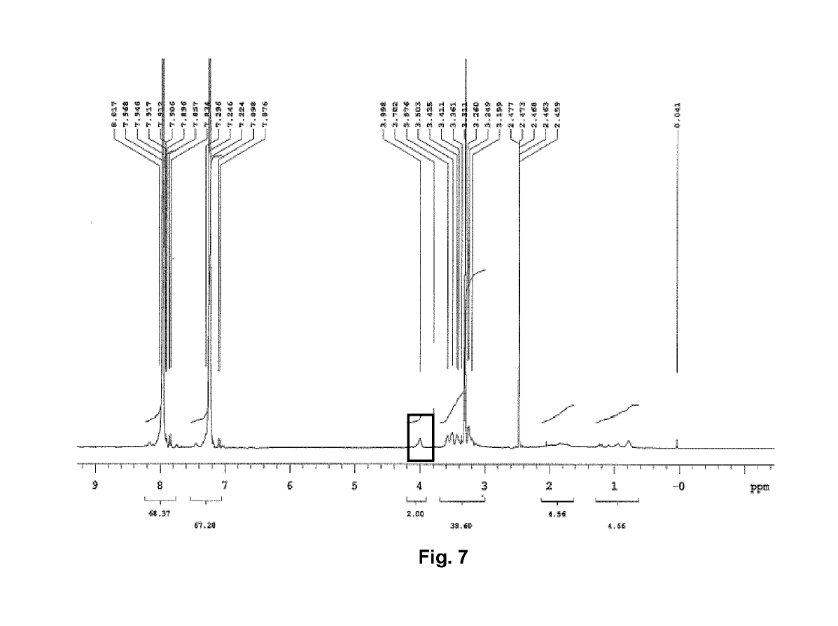

The NMR of hollow fiber with 0%, 2% or 4 wt % additive is shown in FIGS. 5, 6 and 7 respectively.

The ratio of PEGMA/PESU in FIG. 5-7 is tabulated in Table 2 and it can be observed that this ratio increases as an increasing amount of additive is added. This also proves that hypochlorite etching does not destroy/remove additive from the membrane.

TABLE 2
Peak ratio of PEGMA/PES as a function of additive concentration

| | Peak ratio of |
|---|---|
| Membrane ID | PEGMA/PESU |
| 0% MM1* | −/12.02 |
| 2% MM1* | 1/28.62 |
| 4% MM1* | 1/17.09 |

*MM1 is PPEGMA-b-PESU-b-PPEGMA with 23 wt % PPEGMA

### Example 3b

### Single Hollow Fiber Fabrication and Testing (Compared with and without Additive of the Invention)

Dope solutions with the following compositions were prepared.

TABLE 3
Dope compositions of standard and MM1-incorporated membranes

| | PESU3010 | PVP K90 | Glycerin | NMP | Additive | Viscosity |
|---|---|---|---|---|---|---|
| Membrane ID | (wt %) | (wt %) | (wt %) | (wt %) | (wt %) | (mPa · s) |
| Standard | 15.6 | 4.8 | 8 | 71.6 | — | 13296 ± 419 |
| membrane | | | | | | (clear dope) |
| MM1- | 13.6 | 4.8 | 8 | 69.6 | 4 | 11750 ± 125 |
| incorporated | | | | | | (clear dope) |
| membrane | | | | | | |

The dope solutions were left to stir overnight till a homogeneous solution was obtained. Subsequently, the dope solution was poured into the ISCO pump and left overnight for degassing.

Prior to spinning, the dope solutions were heated at 60° C. in the jacketed ISCO pump. Hollow fibers were fabricated with the following spinning conditions with an in-house hollow fiber spinning line. The dope solution was extruded through a spinneret and entered a coagulation bath filled with tap water at 50° C.

TABLE 4
Spinning conditions for standard membrane 1

| Condition | UF-HF-STD-A | UF-HF-STD-B | UF-HF-STD-C |
|---|---|---|---|
| Dope composition | PESU E3010/PVP K90/Glycerin/ | | |
| (wt %) | NMP = 15.6/4.8/8/71.6 | | |
| Dope flow rate | 2.5 | | |
| (ml/min) | | | |
| Bore composition | water | NMP/water = | NMP/water = |
| (wt %) | | 5/95 | 10/90 |

| | |
|---|---|
| Bore flow rate | 3.5 |
| (ml/min) | |
| Air gap (cm) | 20 |
| Take up speed | 7 |
| (cm/s) | |
| External coagulant | Tap water (50 ± 2° C.) |
| (wt %) | |

TABLE 5
Spinning conditions for 4 wt % MM1-incorporated membrane

| Condition | UF-HF-MM1-1A | UF-HF-MM1-1B | UF-HF-MM1-1C |
|---|---|---|---|
| Dope composition | PESU E3010/PVP K90/Glycerin/NMP/MM1 = | | |
| (wt %) | 13.6/4.8/8/69.6/4 | | |
| Dope flow rate | 2.5 | | |
| (ml/min) | | | |
| Bore composition | water | NMP/water = | NMP/water = |
| (wt %) | | 5/95 | 10/90 |

| | |
|---|---|
| Bore flow rate | 3.5 |
| (ml/min) | |
| Air gap (cm) | 20 |
| Take up speed | 7 |
| (cm/s) | |
| External coagulant | Tap water (50 ± 2° C.) |
| (wt %) | |

The as-spun hollow fibers were immersed in deionized (DI) water overnight to ensure complete solvent exchange. The hollow fibers were then etched in 2000 ppm sodium hypochlorite solution at 60° C. for 2 hours, followed by rinsing in DI water for 3 times at 30 minutes intervals. A bundle of hollow fibers were freeze-dried for FESEM characterization. The remaining hollow fibers were then immersed in 50/50 wt % water/glycerol solution for 48 hours. Five hollow fibers were selected and assembled for each module and the module ends were potted with epoxy. The hollow fiber modules were tested using an in-house ultrafiltration (UF) testing setup.

Water permeability of the membranes was tested as follows:
1. DI water was used as the feed and pumped into the lumen side of the hollow fibers at 0.4 L/min with a transmembrane pressure (TMP) of 0.4 bar
2. The hollow fibers were left to stabilize for 30 minutes
3. 3 permeate reading were taken as average

The molecular weight cut-off (MWCO) of the membranes was tested as follows:
1. 1000 ppm PEG/PEO solution was used as the feed and pumped into the lumen side of the hollow fibers at 0.4 L/min with a transmembrane pressure (TMP) of 0.15 bar
2. The hollow fibers were left to stabilize for 15 minutes
3. The feed and permeate were collected and analyzed by a gel permeation chromatography (GPC) instrument and MWCO was calculated.

As observed from the FESEM images (not shown) the hollow fibers have a very porous outer surface as compared to the inner surface. Both, the standard membrane and the MM1-incorporated membrane, give similar FESEM observations.

TABLE 6
Water permeability and MWCO results of standard and 4 wt %
MM1-incorporated membranes

| | Water permeability | MWCO |
|---|---|---|
| Membrane ID | (LMH/bar) | (kDa) |
| Standard membrane | 694 ± 67 | 62 ± 8 |
| (UF-HF-STD-B) | | |
| 4 wt % MM1- | 663 ± 41 | 80 ± 2 |
| incorporated | | |
| membrane | | |
| (UF-HF-MM1-1C) | | |

### Example 3c

### Single Hollow Fiber Fabrication and Testing (Compared with and without Additive)

TABLE 7
Spinning conditions for standard membrane 2

| Condition | UF-HF-STD-2A | UF-HF-STD-2B |
|---|---|---|
| Dope composition (wt %) | PESU E3010/PVP K90/Glycerin/ | |
| | NMP = 13/6.4/6.4/74.2 | |
| Dope flow rate (ml/min) | 2.5 | |
| Bore fluid composition (wt %) | NMP/water = 10/90 | NMP/water = 20/80 |

| | |
|---|---|
| Bore fluid flow rate (ml/min) | 3.5 |
| Air gap distance (cm) | 20 |
| Take up speed (cm/s) | 7 |
| Coagulation bath | Tap water (50 ± 2° C.) |

TABLE 8
Spinning conditions for 2 wt % MM1-incorporated membrane

| Condition | UF-HF-MM1-2A | UF-HF-MM1-2B | UF-HF-MM1-2C | UF-HF-MM1-2 |
|---|---|---|---|---|
| Dope composition | PESU E3010/PVP K90/Glycerin/NMP/MM1 = 13/6.4/6.4/72.2/2 | | | |
| (wt %) | | | | |
| Dope flow rate | 2.5 | | | |
| (ml/min) | | | | |
| Bore composition | NMP/water = | NMP/water = | NMP/water = | water |
| (wt %) | 10/90 | 20/80 | 30/70 | |

| | |
|---|---|
| Bore flow rate | 3.5 |
| (ml/min) | |
| Air gap (cm) | 20 |
| Take up speed | 7 |
| (cm/s) | |
| External | Tap water (50 ± 2° C.) |
| coagulant (wt %) | |

Hollow fibers from dope compositions listed in Table 7 and 8 were spun according to the procedure in Example 3b.

The as-spun hollow fibers were immersed in deionized (DI) water overnight to ensure complete solvent exchange. The hollow fibers were then etched in 2000 ppm sodium hypochlorite solution at 60° C. for 2 hours, followed by rinsing in DI water for 3 times at 30 minutes intervals. A bundle of hollow fibers were freeze-dried for TOF-SIMS characterization. The remaining hollow fibers were then immersed in 50/50 wt % water/glycerol solution for 48 hours. Five hollow fibers were selected and assembled for each module and the module ends were potted with epoxy. The hollow fiber modules were tested using an in-house ultrafiltration (UF) testing setup. The procedure is similar to that in Example 3b.

TABLE 9
Water permeability and MWCO results of standard membrane 2 and
2 wt % MM1-incorporated membrane

| | Water permeability | MWCO |
|---|---|---|
| Membrane ID | (LMH/bar) | (kDa) |
| Standard membrane | 512 ± 41 | 136 ± 9 |
| (UF-HF-STD-2B) | | |
| 2 wt % MM1- | 426 ± 31 | 112 ± 15 |
| incorporated | | |
| membrane | | |
| (UF-HF-MM1-2B) | | |

### Example 4

### Antifouling Tests of Hollow Fiber Membranes

a) Fouling Tests (Bovine Serum Albumin, BSA) with Membranes Prepared in Example 3a

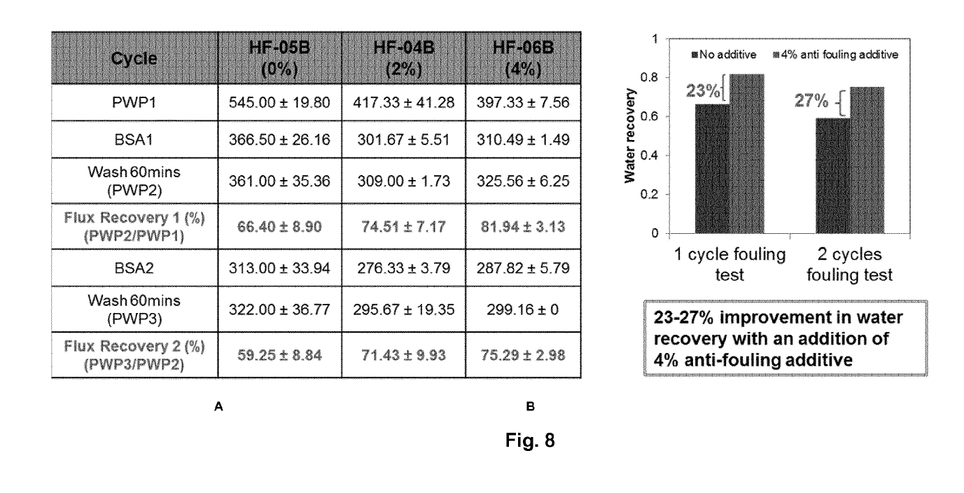

DI water was filled in the UF system and modules were run at about 0.6 bar for 30 minutes and pure water flux (PWP1) reading was taken. 0.5 g/L BSA solution (pH=6.8) was circulated for 30 minutes at 0.6 bar and BSA1 reading was taken. DI water was circulated once for 30 minutes for washing. Fresh DI water was loaded and circulated for another 30 minutes. PWP2 reading was taken. Steps 2-4 were repeated for one more cycle. Flux recovery was calculated. Flux recovery 1=PWP2/PWP1. Flux recovery 2=PWP3/PWP2 (see FIG. 8).

FIG. 8. shows the comparison of water recovery of BSA fouling test for hollow fiber with and without additives. It can be observed that the hollow fibers with 4% additive give the best water recovery of about 75% after 2 cycles of BSA fouling test. This also translates to the PEGMA additive being able to provide anti-fouling property to the hollow fiber.

b) Fouling Tests (Bovine Serum Albumin BSA) with Membranes Prepared in Example 3c

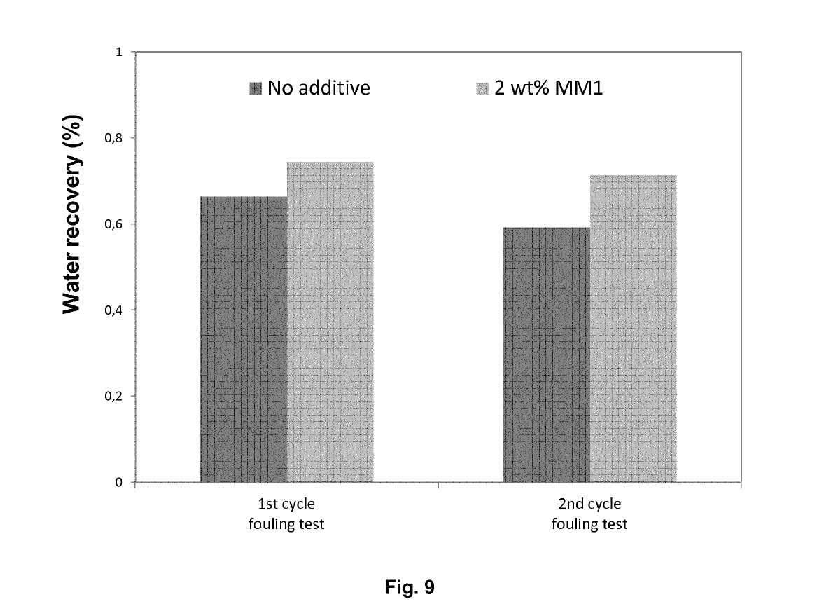

FIG. 9. shows the comparison of water recovery of BSA fouling test for hollow fiber with 2% additive and without additives. It can be observed that the hollow fibers with 2% additive give the best water recovery of about 71.4% after 2 cycles of BSA fouling test.

c) Fouling Tests (Soil Extract) with Membranes Prepared in Example 3b

Further antifouling tests were carried out by soil extract fouling tests according to the following procedure:
1. DI water was filled in the UF system and modules were run at 0.4 bar, 0.4 L/min for 30 minutes and water permeability measurements were taken.
2. Soil extract (pH=13 was diluted 2000 times and adjusted to pH=8)
3. This solution was circulated for 30 minutes at 0.6 bar, 0.4 L/min and Soil1 reading was taken
4. DI water was circulated for 60 minutes at 0.4 bar, 0.6 L/min for washing and changed at 30 minutes interval
5. Water permeability after washing was recorded
6. Steps 2-4 were repeated for 3 cycles.

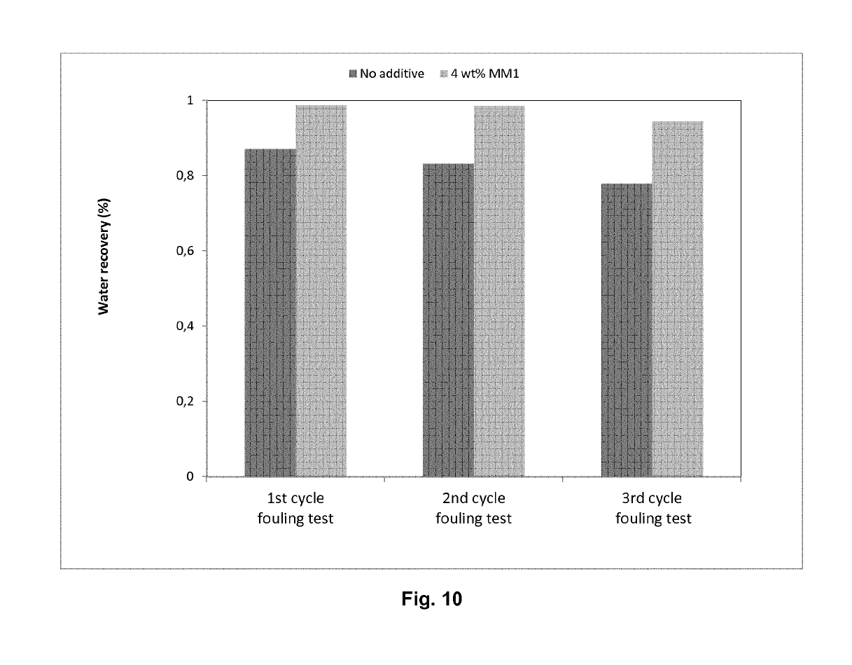

FIG. 10 shows that under fouling tests using soil extract, the standard membranes had a water recovery of 77.9% while the MM1-incorporated membrane had a water recovery of 94.5%. This is an improvement of about 21.3%.

### Example 5

### Antimicrobial Test of Flat Sheet Membranes with Additive of Example 2.13

Antimicrobial test was carried out following the standard of JIS Z 2801.

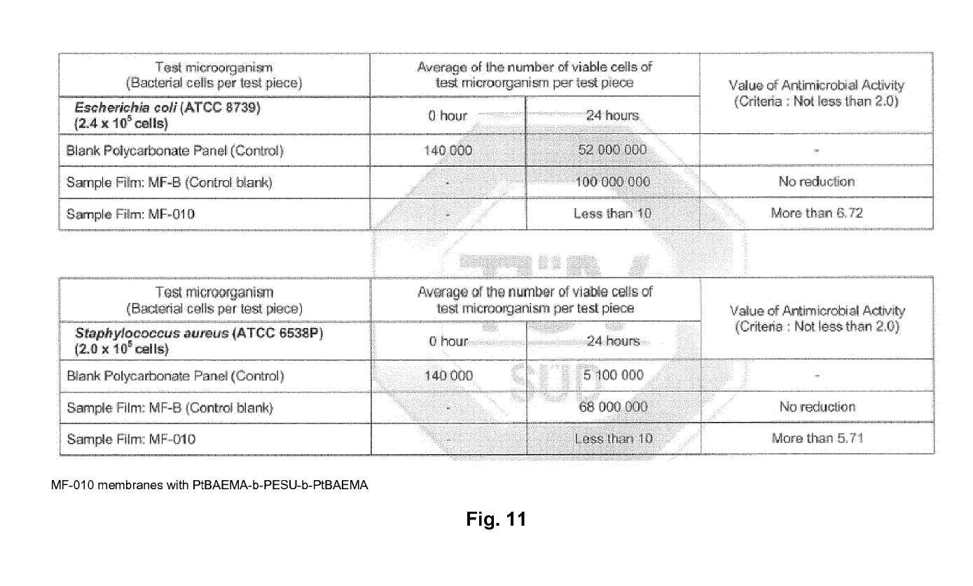

Fabricated membrane demonstrated strong antimicrobial performance against E. Coli and S. Aureus (FIG. 11, MF-010 is the membrane containing as additive PtBAEMA-b-PESU-b-PtBAEMA with 31 w % PtBAEMA).

### Example 6

### Fabrication of Multibore Ultrafiltration Membrane with PESU-b-PEGMA Additive (MM1)

Dope compositions for multibore spinning are stated in Table 10. Post-treatment of multibore is the same as stated in Example 3b. Thereafter, the multibore fibers were subjected to water flux and MWCO testing following the procedure in Example 3b. Mechanical testing was conducted to investigate elongation at break for the multibore fibers.

TABLE 10
Dope composition for multibore spinning and UF performances

| | | | | |
|---|---|---|---|---|
| | 1st | | 2nd | |
| | spinning | 2nd spinning | spinning | 2nd spinning |
| Composition | (MB13- | (condition 1- | (condition 2- | (condition 3- |
| (%) | 051A) | B14-039A) | MB14-039B) | MB14-039G) |

| | | |
|---|---|---|
| PESU 3020 | 17 | 16 |
| PVP K90 | 6.5 | 6.5 |
| MM1 additive | 4 | 4 |
| Glycerin | 10 | 10 |
| NMP | 62.5 | 63.5 |

Testing performance

| | | | | |
|---|---|---|---|---|
| Water flux | 607 | 744 | 1568 | 939 |
| (LMH/bar) | | | | |
| MWCO (kDa) | 61 | 203 | >1000 | 155.5 |
| Elongation (%) | 60 | 30.2 | 27.7 | 29.0 |

The multibore fibers with the code MB13-051A were subjected to pilot testing with seawater at Public Utility Board (PUB) facility in Singapore. Initial testing was conducted and described for UF 100 (MM1 module) as compared to standard UF 200 (standard made of polyethersulfone material without additive). Testing conditions are listed in Table 11.

TABLE 11
Testing conditions

| | | | |
|---|---|---|---|
| Step | | UF100-MM1 | UF200-PESU |
| | | additive | standard |
| Start | | Nov. 7, 2014 | Nov. 7, 2014 |
| Day of the week | | Friday | Friday |
| Module code | | TK14A09-01/GO | TK14A24- |
| | | Area | 12/SH |
| | | (0.165 m\hat{ }2) | |
| Starting conditions | | | |
| pbot im FFB 20 l/h | mbar | 226.9 | 204.9 |
| ptop im FFB 20 l/h | mbar | −50.9 | −19.7 |
| Different pbot and ptop | mbar | 277.8 | 224.6 |
| pfiltrat in BWB 230 lmh | mbar | 720.5 | 367.5 |
| pfiltrat in BWT 230 lmh | mbar | 532.4 | 324.1 |
| Δp in I-Test | mbar | 29 | 10 |
| TMP for 10 Min. Filtration | mbar | 201.9 | 90.8 |
| Water permeability | l/m²hmbar | 556.6 | 932.2 |
| for 10 Min. Filtration | | | |

The multibore with additive shows 20% higher water productivity compared to standard and less than 30% cleaning frequency compared to standard.

Similarly, multibore with additive was subjected to TOF SIMS measurement to prove that the additive is migrating to the surface after fabrication.

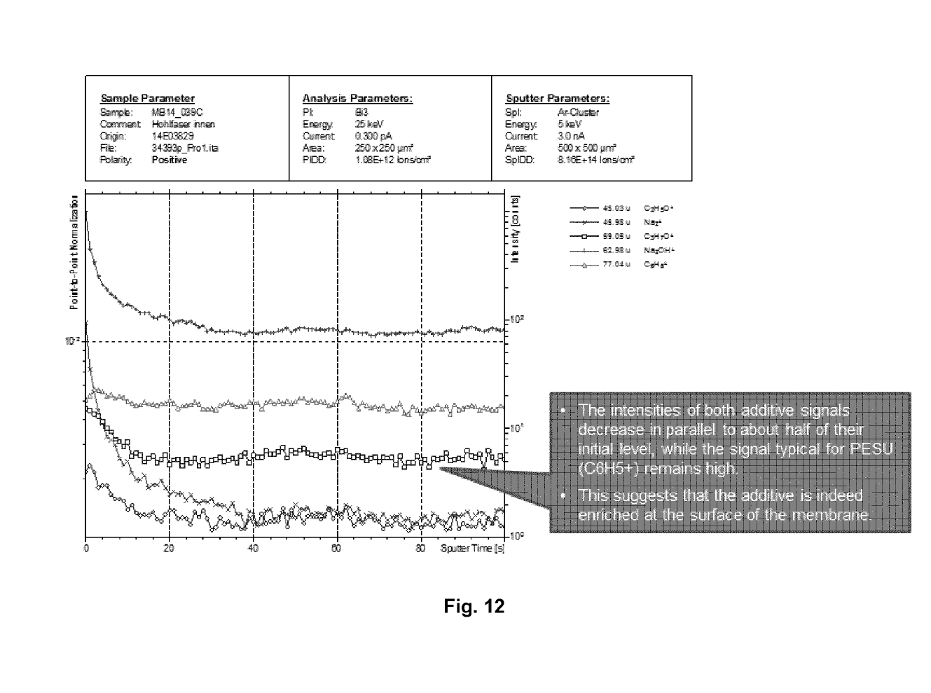

FIG. 12 shows TOF SIMS depth profiling results for a multibore UF membrane with additive MM1. Two signals related to MM1 additive were used for depth profiling: C₂H₅O and C₃H₇O. TOF SIMS results show that the additive migrates to the membrane surface.

### LIST OF REFERENCES

1) (a) Y. K. Han, S. D. Chi, Y. H. Kim, B. K. Park, J. I. Jin, Macromolecules 28 (1995) 916-921. (b) J. H. Botkin, R. J. Cotter, M. Matzner, G. T. Kwiatkowski, Macromolecules 26 (1993) 2372-2376.
2) (a) H. Yamamura, K. Kimmura, Y. Watabab, Environ. Sci. Technol. 41 (2007) 6789-6794. (b) H. Susanto, M. Ulbricht, Water Res. 42 (2008) 2827-2835. (c) M. D. Kennedy, H. K. Chun, Desalination 178 (2005) 73-83.

The disclosure of herein cited documents is incorporated by reference.

1: A porous separation membrane, comprising:
a porous surface layer, said surface layer comprising a polymer composition comprising a polymeric bulk material (P1) in admixture with an amphiphilic polyethersulfone block copolymer (P2),
wherein the amphiphilic polyethersulfone block copolymer (P2) comprises:
at least one hydrophobic block unit (A) and
at least one hydrophilic block unit (B) of general formulae: 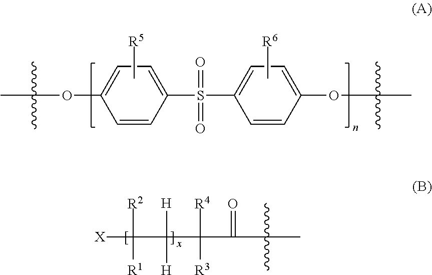
wherein:
R¹ is —COO-alkylene-OR⁷, —COO-alkylene-SO₃⁻M⁺, —COO-alkylene-NR⁸R⁹R¹⁰—COO-alkylene-NHR⁸, —COO-alkylene-N⁺R⁸R⁹R¹¹W⁻—CO—Z—N—R⁸R⁹, or optionally substituted N-heterocyclyl;
R² is hydrogen, halogen, optionally substituted alkyl, perfluorinated alkyl, optionally substituted aryl, cyano, nitro, amino, or heterocyclyl;
R³, R⁴ independently are hydrogen, halogen, optionally substituted alkyl, perfluorinated alkyl, optionally substituted aryl, cyano, nitro, amino, or heterocyclyl;
R⁵, R⁶ independently are hydrogen, halogen, or sulfonic acid;
n is an integer in a range from 20 to 80;
x is an integer in a range from 1 to 20;
R⁷ is hydrogen, alkyl, or alkoxy-alkyl;
R⁸, R⁹ independently are hydrogen, optionally substituted alkyl;
R¹⁰ is -alkylene-SO₃⁻;
is hydrogen, alkyl, or aryl-alkyl,
is alkylene or a chemical bond;
X is halogen, hydrogen or another block unit (B) wherein X, x, and R¹ to R⁴ are as defined above;
W is halogen, OTf, BF₄, BPh, PF₆ or SbF₆;
M is alkaline metal or alkaline earth metal;
wherein said polymeric bulk material (P1) is polyethersulfone (PESU), sulfonated polyethersulfone, polysulfone (PSU), sulfonated polysulfone, polyphenylsulfone (PPSU), or sulfonated polyphenylsulfone, or blends thereof, and
wherein the weight ratio of P1:P2 is in the range of 1:0.02 to 0.3.

2: The membrane of claim 1, wherein the amphiphilic polyethersulfone block copolymer (P2) comprising:
at least one hydrophobic block unit (A); and
at least one hydrophylic block unit (B);
has the structure B-A or B-A-B.

3: The membrane of claim 1, wherein the amphiphilic polyethersulfone block copolymer (P2) has the general formula (I) 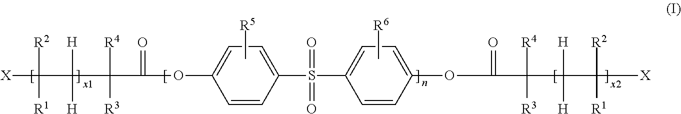
wherein x¹ and x² independently have the meaning of x and R¹, R², R³, R⁴, R⁵, R⁶, X, n and x are as defined in claim 1.

4: The membrane of claim 3, comprising:
an amphiphilic polyethersulfone block copolymer (P2) of the general formula (I), wherein
R¹ is —COO-alkylene-OR⁷, —COO-alkylene-SO₃⁻—COO-alkylene-NR⁸R⁹R¹⁰—COO-alkylene-NHR⁸, or N-pyrrolidonyl;
R² is hydrogen or alkyl;
R³, R⁴ independently are alkyl;
R⁵, R⁶ are hydrogen;
n is an integer in a range from 20 to 80;
x¹, x² independently are integers in a range from 1 to 20;
R⁷ is hydrogen or alkoxy-alkyl;
R⁸, R⁹ independently are hydrogen, alkyl;
R¹⁰ is -alkylene-SO₃⁻;
X is halogen or hydrogen; and
M is alkaline metal or alkaline earth metal.

5: The membrane of claim 3, comprising:
a bulk material (P1) and
an amphiphilic polyethersulfone block copolymer (P2) of the general formula (I), wherein
R¹ is —COO—(CH₂)₂—OR⁷, —COO—(CH₂)₃—SO₃⁻—COO-alkylene-NR⁸R⁹R¹⁰, COO-alkylene-NHR⁸, or N-pyrrolidonyl;
R² is hydrogen or methyl;
R³, R⁴ are methyl;
R⁵, R⁶ are hydrogen;
n is an integer in a range from 20 to 80;
x¹, x² independently are integers in a range from 1 to 20;
R⁷ is hydrogen or 2-methoxy-ethyl;
R⁸, R⁹ independently are hydrogen, methyl, or tert-butyl;
R¹⁰ is —(CH₂)₃—SO₃;
X is hydrogen or bromine;
M is alkaline metal.

6: The membrane of claim 3, wherein said amphiphilic polyethersulfone block copolymer (P2) is 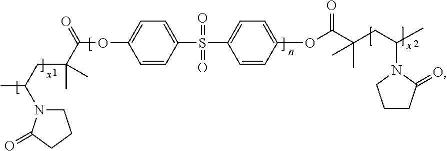
wherein x¹, x² and n are as defined above.

7: The membrane of claim 1, wherein said amphiphilic polyethersulfone block copolymer (P2) comprises at least one hydrophilic unit (B) in an amount in the range of 8 to 80 wt. % per total weight of the dried block copolymer (P2).

8: The membrane of claim 1, wherein said amphiphilic polyethersulfone block copolymer (P2) is obtainable by polymerizing a macroinitiator of the general formula M1a and atom transfer radical polymerization active monomers of general formula M1b 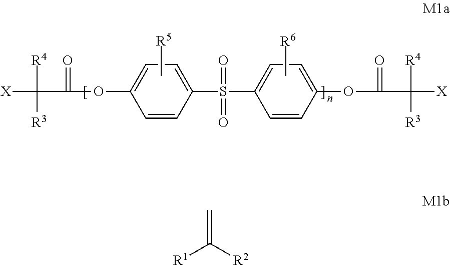
wherein R¹, R², R³, R⁴, R⁵, R⁶ and n are as defined above, and
Y is F, Cl, Br or I.

9: The membrane of claim 1, wherein said amphiphilic polyethersulfone block copolymer (P2) has a Mw in the range of from 10,000 to 100,000 g/mol, as determined by Gel Permeation Chromatography (GPC) in N-dimethylacetamide (DMAc).

10: The membrane of claim 1, wherein said amphiphilic polyethersulfone block copolymer (P2) has a polydispersity index in the range of 2 to 5, as determined by Gel Permeation Chromatography in N-dimethylacetamide.

11: The membrane of claim 1, which is in the form of a sheet or hollow fiber.

12: The membrane of claim 11, wherein said amphiphilic polyethersulfone block copolymer (P2) is contained as additive in a polymeric solution applied for preparing said porous surface layer in an amount of from 0.1 to 20 wt. %, based on the total weight of the polymer solution.

13: The membrane of claim 11, which is an ultrafiltration membrane.

14: An ultrafiltration method, comprising:
passing a fluid through a membrane of claim 13.

15: A method of preparing a porous separation membrane of any of the claim 11, which method comprises:
providing a dope solution comprising a dope solvent and a polymer composition dissolved in said dope solvent;
performing casting and spinning of said dope solution to form a polymer sheet or fiber structure; and
performing a phase inversion by contacting said sheet or fiber structure with a liquid coagulation medium.
